(19) United States
(12) Patent Application Publication
(10) Pub. No.: US 2021/0390515 A1
(43) Pub. Date: Dec. 16, 2021

(54) MANAGEMENT ASSISTANCE DEVICE, MANAGEMENT SYSTEM, AND NON-TRANSITORY RECORDING MEDIUM

(71) Applicant: Ryoh Tomosugi, KANAGAWA (JP)

(72) Inventor: Ryoh Tomosugi, KANAGAWA (JP)

(73) Assignee: Ricoh Company, Ltd., Tokyo (JP)

(21) Appl. No.: 17/330,777

(22) Filed: May 26, 2021

(30) Foreign Application Priority Data
Jun. 12, 2020 (JP) 2020-101955

(51) Int. Cl. G06Q 10/10; H04L 29/08; G06K 7/14; G06Q 10/08; G06Q 10/02; G06Q 10/06

(52) U.S. Cl. CPC G06Q 10/1095; H04L 67/18; G06Q 10/105; G06Q 10/06315; G06K 7/1447; G06Q 10/087; G06Q 10/02; G06K 7/1417

(57) ABSTRACT

A management assistance device includes circuitry that receives, from a communication terminal used by a user, user identification information identifying the user and resource identification information identifying a specific resource that is used by the user. The specific resource is a resource other than resources whose reservations are managed by a reservation management device. The circuitry further transmits, to an administrator terminal used by an administrator who manages the user, user information and location information. The user information indicates a user name of the user who uses the specific resource and is identified by the user identification information. The location information indicates a location of the specific resource identified by the resource identification information.

### CROSS-REFERENCE TO RELATED APPLICATION

This patent application is based on and claims priority pursuant to 35 U.S.C. § 119(a) to Japanese Patent Application No. 2020-101955, filed on Jun. 12, 2020, in the Japan Patent Office, the entire disclosure of which is hereby incorporated by reference.

### BACKGROUND

### Technical Field

Embodiments of the present disclosure relate to a management assistance device, a management system, and a non-transitory recording medium.

### Related Art

A technique in which an information processing terminal provided in a resource such as a meeting room displays information on one or more reservations for the resource, such as the meeting room, is known. With this technique, a user inputs a start of use of the meeting room to the information processing terminal when the user starts using the meeting room and inputs an end of use of the meeting room to the information processing terminal when the user finishes using the meeting room.

In addition, in order to prevent a case in which a specific worker always uses a specific desk in a non-territorial office, a technique in which current usage statues of all desks in the non-territorial office are referred, and available desks are selected to be randomly assigned one by one to each of the users (workers) has been devised.

### SUMMARY

An exemplary embodiment of the present disclosure includes a management assistance device including circuitry that receives, from a communication terminal used by a user, user identification information identifying the user and resource identification information identifying a specific resource that is used by the user. The specific resource is a resource other than resources whose reservations are managed by a reservation management device. The circuitry further transmits, to an administrator terminal used by an administrator who manages the user, user information and location information. The user information indicates a user name of the user who uses the specific resource and is identified by the user identification information. The location information indicates a location of the specific resource identified by the resource identification information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of an overall configuration of a management system according to one or more embodiments of the disclosure;

FIG. 2 is a block diagram illustrating an example of a hardware configuration of a smartphone according to one or more embodiments of the disclosure;

FIG. 3 is a block diagram illustrating an example of a hardware configuration of each of a reservation management server, a management assistance server, and a personal computer (PC) according to one or more embodiments of the disclosure;

FIG. 4 (FIG. 4A and FIG. 4B) is a block diagram illustrating an example of a functional configuration of a management system according to one or more embodiments of the disclosure;

FIG. 5A is a diagram illustrating an example of a user identification (ID) registration management table according to one or more embodiments of the disclosure;

FIG. 5B is a diagram illustrating an example of an authentication information management table according to one or more embodiments of the disclosure;

FIG. 5C is a diagram illustrating an example of an administrator ID registration table according to one or more embodiments of the disclosure;

FIG. 6 is a diagram illustrating an example of a personal reservation management table according to one or more embodiments of the disclosure;

FIG. 7 is a diagram illustrating an example of a resource reservation management table according to one or more embodiments of the disclosure;

FIG. 8A is a diagram illustrating an example of an authentication information registration table according to one or more embodiments of the disclosure;

FIG. 8B is a diagram illustrating an example of an account information management table according to one or more embodiments of the disclosure;

FIG. 9 is a diagram illustrating an example of a management target user registration table according to one or more embodiments of the disclosure;

FIG. 10 is a diagram illustrating an example of a shared workspace management table according to one or more embodiments of the disclosure;

FIG. 11 is a sequence diagram illustrating an example of chat application initial activation process performed in response to a user operation, according to one or more embodiments of the disclosure;

FIG. 12 is a sequence diagram illustrating an example of chat application initial authentication process performed in response to a user operation, according to one or more embodiments of the disclosure;

FIG. 13 is a diagram illustrating an example of a log-in screen displayed with a communication terminal owned or used by a user according to one or more embodiments of the disclosure;

FIG. 14 is a sequence diagram illustrating an example of workspace search process performed according to user operations of a user, according to one or more embodiments of the disclosure;

FIG. 15 is a diagram illustrating an example of a workspace search screen displayed with a communication terminal owned or used by a user according to one or more embodiments of the disclosure;

FIG. 16 is a diagram illustrating another example of a workspace search screen of a communication terminal owned or used by a user according to one or more embodiments of the disclosure;

FIG. 17 is a sequence diagram illustrating an example of a camera activation process and a QR CODE capturing process, each of which is performed in response to a user operation of a user according to one or more embodiments of the disclosure;

FIG. 18 is a sequence diagram illustrating an example of a process for workspace usage, performed according to user operations of a user, according to one or more embodiments of the disclosure;

FIG. 19 is a diagram illustrating an example of a workspace usage screen displayed with a communication terminal owned or used by a user according to one or more embodiments of the disclosure;

FIG. 20 is a diagram illustrating an example of a camera activation screen displayed with a communication terminal owned or used by a user according to one or more embodiments of the disclosure;

FIG. 21 is a diagram illustrating an example of a QR CODE reading screen displayed with a communication terminal owned or used by a user according to one or more embodiments of the disclosure;

FIG. 22 is a diagram illustrating another example of a workspace usage screen of a communication terminal owned or used by a user according to one or more embodiments of the disclosure;

FIG. 23 is a sequence diagram illustrating an example of chat application initial activation process and authentication process performed according to user operations of an administrator, according to one or more embodiments of the disclosure;

FIG. 24 is a diagram illustrating an example of a usage menu display screen displayed with an administrator terminal according to one or more embodiments of the disclosure;

FIG. 25 is a sequence diagram illustrating an example of user search process performed according to user operations of an administrator according to one or more embodiments of the disclosure;

FIG. 26 is a diagram illustrating an example of a user search screen displayed with an administrator terminal according to one or more embodiments of the disclosure;

FIG. 27 is a diagram illustrating an example of a screen displayed with an administrator terminal displaying information on applicable users as a search result, according to one or more embodiments of the disclosure;

FIG. 28 is a sequence diagram illustrating another example of user search process performed according to user operations of an administrator according to one or more embodiments of the disclosure;

FIG. 29 is a diagram illustrating an example of a user search result screen displayed with the administrator terminal according to one or more embodiments of the disclosure;

FIG. 30 is a sequence diagram illustrating an example of user search process performed according to user operations of an administrator according to one or more embodiments of the disclosure;

FIG. 31 is a diagram illustrating an example of a screen displayed with an administrator terminal displaying information on applicable users as a search result according to one or more embodiments of the disclosure;

FIG. 32 is a sequence diagram illustrating an example of a chat application log-out process performed in response to a user operation of a user, according to one or more embodiments of the disclosure;

FIG. 33 is a flowchart illustrating an example of a log-out determination process in relation to a chat application, performed in response to a user operation of a user, according to one or more embodiments of the disclosure;

FIG. 34 is a diagram illustrating an example of a usage menu display screen displayed with a communication terminal owned or used by a user according to one or more embodiments of the disclosure; and

FIG. 35 is a diagram illustrating an example of a log-out screen displayed with a communication terminal owned or used by a user according to one or more embodiments of the disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments of the present disclosure are described with reference to the drawings. In the description of the drawings, the same elements are denoted by the same reference numerals, and redundant descriptions thereof are omitted.

### First Embodiment

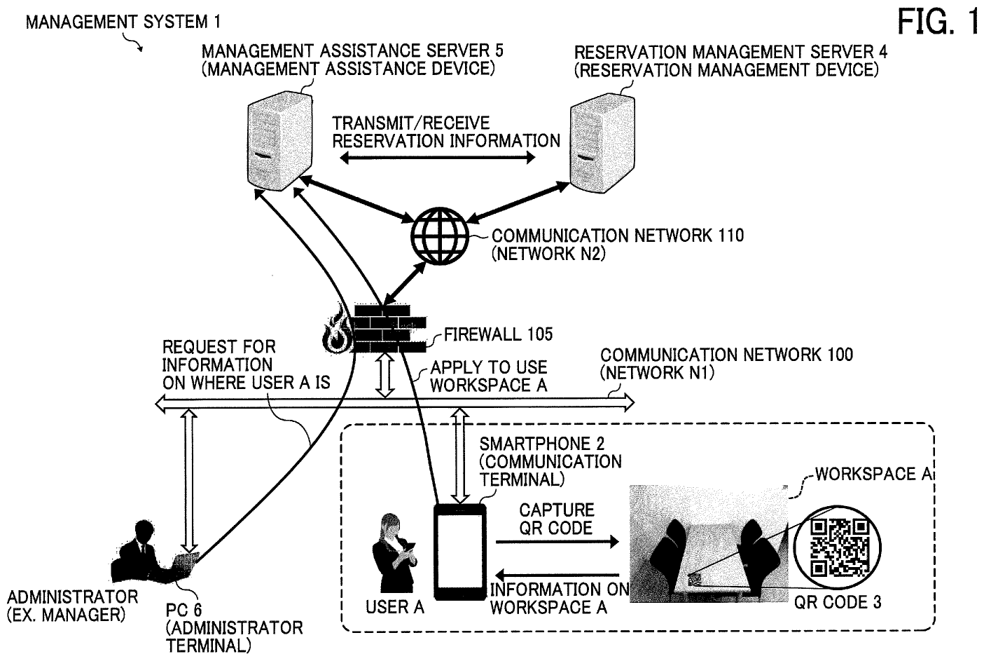

A description is given below of a first embodiment of the present disclosure, with reference to FIG. 1 to FIG. 29.

Overview of Management System:

FIG. 1 is a diagram illustrating an example of an overall configuration of a management system 1 according to the first embodiment of the present disclosure. In the management system 1 as illustrated in FIG. 1, a smartphone 2 owned or used by a user captures an image code such as QR CODE (registered trademark) provided on or in a resource such as a shared workspace and then transmits the captured image of QR CODE to a management assistance server 5. The management assistance server 5 then manages various data corresponding to the image code. Accordingly, the management system 1 allows an administrator who manages the user to get information on a location where the resource reserved by the user is (allows the administrator to know the reserved place, which is where the user is) by using a personal computer (PC) 6 owned or used by the administrator. That is, the management system 1 is a system that assists a managing work of the administrator who manages one or more users who use resources.

Example of System Configuration:

The management system 1 includes a smartphone 2, a reservation management server 4, the management assistance server 5, and the PC 6. The smartphone 2 and the PC 6 are connected to each other inside a firewall 105 through a communication network 100 (network N1) such as an intra-company network. The reservation management server 4 and the management assistance server 5 are connected to the outside of the firewall 105 so as to communicate through a communication network 110 (network N2). The communication network 110 is a network through which an unspecified number of communications are established, and is implemented by the Internet, a mobile communication network, or a Local Area Network (LAN), for example. The communication network 110 may include, in addition to a wired communication, a wireless communication in compliance with, for example, 3rd Generation (3G), 4th Generation (4G), 5th Generation (5G), Worldwide Interoperability for Microwave Access (WiMAX), and Long Term Evolution (LTE).

The smartphone 2 is a communication terminal installed with a general operating system (OS) or the like. Alternative to the smartphone 2, for example, another communication terminal that has a communication function, such as a tablet terminal, a PC, a Personal Digital Assistant (PDA), or a wearable PC, which includes a sunglass type and a wristwatch type, may be used. That is, a terminal capable of executing software such as browser software is used as such a communication terminal.

As an example, dedicated application software (hereinafter referred to as a chat application) that is available with the management assistance server 5 is installed on the smartphone 2. By operating the smartphone 2 on which the chat application is installed, the user is able to reserve, for example, a shared workspace, which is a resource in the present disclosure. In the present embodiment, the management system 1 may include a conference management server (meeting management server) for operating dedicated application software related to a conference (meeting) (hereinafter referred to as a conference application or a meeting application). The above-mentioned application may be substituted by browser software. In the present embodiment, the smartphone 2 functions as an example of a communication terminal.

The reservation management server 4 is implemented by one or more information processing devices (a computer system), each being installed with a general-purpose server OS, for example. A system related to managing with the reservation management server 4 including managing a reservation for a resource and managing a reservation or a schedule made by a user is referred to as a reservation management system. The reservation management server 4 includes a calendar system and provides a web application for managing various schedules for a user. For example, the reservation management server 4 has following functions of:

Accepting a registration of a reservation or a schedule and enabling the user to check the reservation or the schedule from anywhere at any time;

Transmitting a reminder email at a preset date and time, such as 30 minutes before a scheduled time; Enabling the user to manage reservations and schedules by using plural calendars (for business, for family, etc.); and

Sharing a calendar with other members who belongs to the same group. The reservation management server 4 uses accounts to manage the users.

An account represents a user's right to use a corresponding service. In many systems, accounts are used to allow users to log in to the systems. That is, an account has a function (function of identification information) to enable the system to uniquely identify a corresponding user. In the present embodiment, the reservation management server 4 transmits reservation information associated with an account (domain) registered in advance to a meeting management server (conference management server). Alternatively, the meeting management server requests the reservation information by specifying the account of the reservation management server 4, to acquire the reservation information associated with a meeting room (conference room) from the reservation management server 4. The account may be any suitable information that uniquely identifies a user. Examples of the account include an email address, an identification (ID), and a telephone number.

In the present embodiment, the reservation management server 4 manages information on reservations for various types of resources, which includes a shared workspace and a meeting room, and information on scheduled events or user schedules. Although G SUITE (registered trademark), OFFICE 365 (registered trademark), and the like are known as reservation management systems, any other suitable reservation management system having functions described in the present embodiment will suffice.

In addition, in the present embodiment, the reservation management server 4 registers information on various types of resources reserved by each of the users and information on the schedule of each of the users in advance. In other words, the web application of the reservation management server 4 is customized according to a meeting room name, a meeting room ID, a reservation available time, a capacity, a reservation unit, and the like of each meeting room residing within the intra-company network of a company using the management system 1. Accordingly, the resources including each meeting room of the company using the management system 1 is associated with the reservation information. In the present embodiment, the reservation management server 4 functions as an example of a reservation management device.

The management assistance server 5 is implemented by one or more information processing devices (a computer system), each being installed with a general-purpose server OS, for example. A sharing system provided by the management assistance server 5 for sharing information such as texts, sounds, and video images between plural users is referred to as a chat system. The management assistance server 5 notifies the smartphone 2 of information regarding reservations for various resources. In the present embodiment, a plurality of management assistance servers 5 each having different operating entities may be included. In the present embodiment, the management assistance server 5 functions as an example of a management assistance device.

The information shared by the management assistance server 5 is not limited to data representing texts, but includes data also representing such as, for example, images, video images, and sounds. However, in the description of the present embodiment, an example case in which text is mainly used for the notifications, for the sake of explanatory. However, regarding a chat system in the present embodiment, a function of voice chat may be used in communications between the members in the group. The voice chat can be a one-to-one voice chat or a one-to-N voice chat, where N≥2. In other words, when the chat system is used to notify information on the reservation for the resource in the present embodiment, a voice message may be output, in addition to or in alternative to texts displayed. As the chat system, LINE (registered trademark), SLACK (registered trademark), MICROSOFT TEAMS (registered trademark) or the like is known but this is not limiting. Any chat system having a capability of transmitting a notification to one or more users from a bot (a program that executes predetermined processes) will suffice.

Similarly, the management assistance server 5 manages users with an account that is different from the account for the reservation management server 4. The meeting management server basically does not need to recognize the account of the management assistance server 5. However, the meeting management server can transmit a notification by specifying a desired account for the management assistance server 5.

The administrator who manages, for example, schedules of the users uses the PC 6 that is connectable to the communication network 100 inside the firewall 105. The PC 6 establishes wired or wireless communications. The PC 6 is installed with a chat application in substantially the same manner as the smartphone 2. The PC 6 is used as a display terminal for confirming a reservation status of the resource such as a meeting room, a shared workspace, or the like reserved by a user, accordingly. The PC 6 further may have a function of communicating by using browser software and displaying a web page.

Alternative to the PC 6, for example, another communication terminal that has a communication function, such as a tablet terminal, a PDA, or a wearable PC, which includes a sunglass type and a wristwatch type, may be used. That is, the communication terminal to be used may be any terminal capable of executing software such as browser software. In the present embodiment, the PC 6 functions as an example of an administrator terminal, which is a terminal used by the administrator.

Regarding Terms:

The “resource” is defined as various types of resources owned, rented, or managed by a company, a group, an organization, or the like. The resource of a company, a group, an organization, or the like, includes for example, a meeting room, and a facility usable in the meeting room, a device, and a worker (reception group). In addition, the resource includes a shared workspace (non-territorial workspace), a desk, a chair, a place such as a booth, a company car, a bicycle, a parking lot, a bicycle parking lot, a teleconferencing system, and a printing service and mechanism. The shared workspace is a shared space that no one owns in a workplace, namely is available for anyone who belongs to, for example, a company, which owns the shared workspace. Hereinafter the shared workspace may be simply referred to as a shared space, space, or workspace. From among the resources, a resource that is difficult to be moved is referred to as a “facility”. In the description of the present embodiment, for the sake of explanatory convenience, a term of “shared workspace”, is used as an example of the resource. In addition, examples of the resources include various types of electronic devices, places such as rental offices and rental studios, rental cycles, rental cars (sharing cars), accommodation facilities such as hotels, facilities such as entertainment venues, and rental spaces such as rental lockers.

Requesting for usage of a resource may indicate requesting to use a resource with a required resource identification information. For example, “Requesting for usage of a resource” includes requesting to start using a resource and requesting to start a reservation for a resource.

The “user” includes a person who has reserved a resource such as a shared workspace or a meeting room. When a reservation-making user who reserved a certain shared workspace uses the shared workspace, the reservation-making user is a user of the shared workspace.

Hardware Configuration:

Hardware Configuration of Smartphone 2:

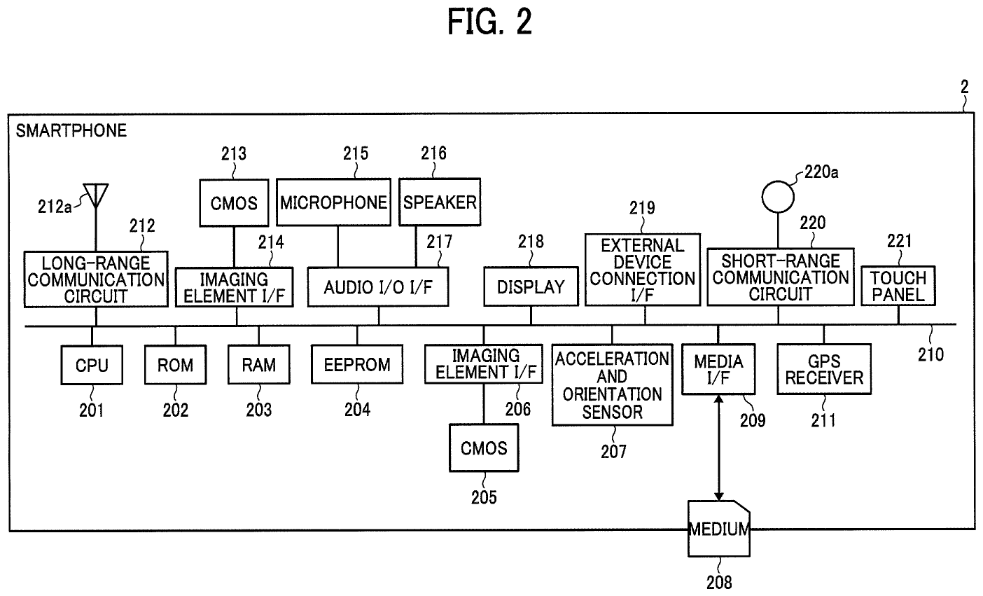

FIG. 2 is a block diagram illustrating an example of a hardware configuration of the smartphone 2 according to the first embodiment of the present disclosure. The smartphone 2 includes a central processing unit (CPU) 201, read only memory (ROM) 202, random access memory (RAM) 203, Electrically Erasable Programmable ROM (EEPROM) 204, Complementary Metal Oxide Semiconductor (CMOS) sensor 205, imaging element interface (I/F) 206, acceleration and orientation sensor 207, media I/F 209, and Global Positioning System (GPS) receiver 211.

The CPU 201 controls entire operation of the smartphone 2. The ROM 202 stores a control program for operating the CPU 201 such as an Initial Program Loader (IPL). The RAM 203 is used as a work area for the CPU 201. The EEPROM 204 reads or writes various data such as an application under control of the CPU 201. The CMOS sensor 205 is an example of a built-in imaging element that captures an object under control of the CPU 201 to obtain image data or video data. In alternative to the CMOS sensor 205, an imaging element such as a charge-coupled device (CCD) sensor may be used as an image capturing device. The imaging element I/F 206 is a circuit that controls driving of the CMOS sensor 205. The acceleration and orientation sensor 207 includes various sensors such as an electromagnetic compass or gyrocompass for detecting geomagnetism and an acceleration sensor. The media I/F 209 reads or writes (stores) data from and to a storage medium 208 such as a flash memory. The GPS receiver 211 receives a GPS signal from a GPS satellite.

The smartphone 2 further includes a long-range communication circuit 212, an antenna 212a for the long-range communication circuit 212, a CMOS sensor 213, an imaging element I/F 214, a microphone 215, a speaker 216, an audio input/output (I/O) I/F 217, a display 218, an external device connection I/F 219, a short-range communication circuit 220, an antenna 220a for the short-range communication circuit 220, and a touch panel 221.

The long-range communication circuit 212 is a circuit that enables the smartphone 2 to communicate with other devices through the communication network 100. The CMOS sensor 213 is an example of a built-in imaging element that captures an object under control of the CPU 201 to obtain image data. The imaging element I/F 214 is a circuit that drives the CMOS sensor 213. The microphone 215 is a built-in circuit that converts sound into an electric signal. The microphone 215 acquires voice and sound waves emitted from an external speaker, etc., and acquires information using electrical signals. The speaker 216 is a built-in circuit that generates audio such as music or voice by converting an electric signal into physical vibration. The audio input/output I/F 217 is a circuit for inputting or outputting an audio signal between the microphone 215 and the speaker 216 under control of the CPU 201. The display 218 is an example of a display device that displays an image of the object, various icons, etc. Examples of the display 218 include a Liquid Crystal Display (LCD) and an organic electroluminescence (EL) display. The external device connection I/F 219 is an interface that connects the smartphone 2 to various external devices. The short-range communication circuit 220 is a communication circuit that communicates in compliance with the Near Field Communication (NFC), the Bluetooth, or the like. The touch panel 221 is one example of an input device that allows a user to operate the smartphone 2 by performing a user operation. Examples of the user operation includes operations of pressing, clicking, and tapping performed with respect to a screen of the display 218. The imaging element such as the CMOS sensor 213, the short-range communication device such as the short-range communication circuit 220, the voice input device such as the microphone 215, and the like are information acquisition devices that acquire resource identification information by, for example, an image such as an image code, wireless communication, or sound waves.

The smartphone 2 further includes a bus line 210. The bus line 210 is an address bus or a data bus that electrically connects the elements illustrated in FIG. 2, such as the CPU 201, to each other.

Hardware Configuration of Reservation Management Server, Management Assistance Server, or Administrator Terminal:

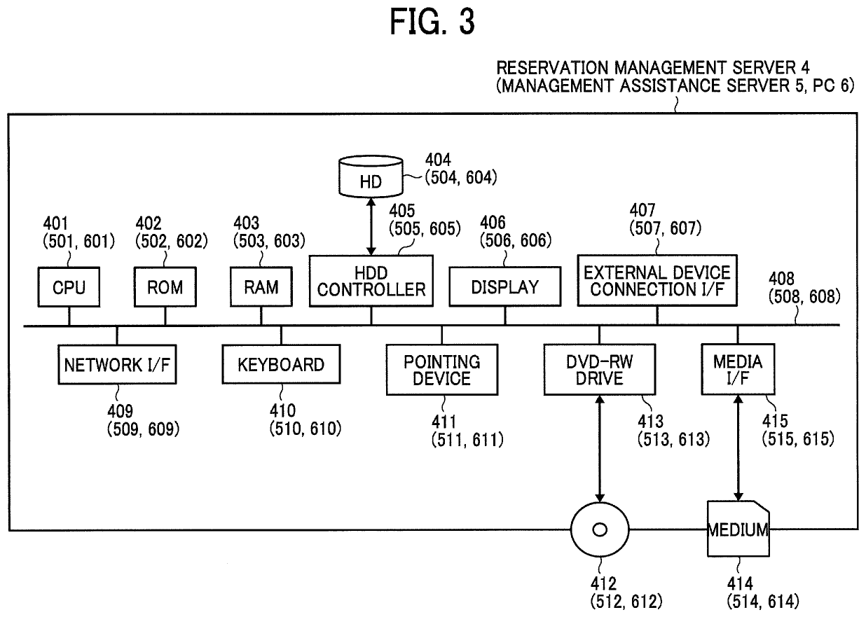

FIG. 3 is a block diagram illustrating an example of a hardware configuration of each of the reservation management server 4, the management assistance server 5, and the PC 6 according to the present embodiment. Each of the reservation management server 4 and the management assistance server 5, and the PC 6 is implemented by, for example, a computer system having a hardware configuration as illustrated in FIG. 3.

The computer system illustrated in FIG. 3 is implemented by a computer, and includes a CPU 401, a ROM 402, a RAM 403, a Hard Disk (HD) 404, a Hard Disk Driven (HDD) controller 405, a display 406, an external device connection I/F 407, a bus line 408, a network I/F 409, a keyboard 410, a pointing device 411, a Digital Versatile Disk Rewritable (DVD-RW) drive 413, and a media I/F 415.

The CPU 401 controls entire operation of the computer system. The ROM 402 stores programs including an IPL to boot the CPU 401. The RAM 403 is used as a work area for the CPU 401. The HD 404 stores various data such as a control program. The HDD controller 405 reads or writes various data from and to the HD 404 under control of the CPU 401. The display 406 displays various information such as a cursor, a menu, a window, a character, or an image. The external device connection I/F 407 is an interface for connecting to various external devices. The external device is, for example, a Universal Serial Bus (USB) memory or a printer. The network I/F 409 is an interface for data communication by using the communication network 110. The bus line 408 is an address bus or a data bus that electrically connects the elements illustrated in FIG. 3, such as the CPU 401, to each other.

The keyboard 410 is an example of an input device provided with a plurality of keys for allowing a user to input characters, numerals, or various instructions. The pointing device 411 is an example of an input device that allows a user to select or execute a specific instruction, select a target for processing, or move a cursor being displayed. The media I/F 415 reads and writes (stores) data from and to a storage medium 414 such as a flash memory. The DVD-RW drive 413 reads and writes various data from and to a DVD-RW 412, which is an example of a removable recording medium (removable storage medium). The removable recording medium (removable storage medium) is not limited to the DVD-RW and may be a digital versatile disk-recordable (DVD-R) or the like.

The management assistance server 5 is implemented by a computer, and as illustrated in FIG. 3, includes a CPU 501, a ROM 502, a RAM 503, an HD 504, an HDD controller 505, a display 506, an external device connection I/F 507, a bus line 508, a network I/F 509, a keyboard 510, a pointing device 511, a DVD-RW drive 513, and a media I/F 515. The above-mentioned elements of the management assistance server 5 are substantially the same as the elements of the reservation management server 4, the CPU 401, the ROM 402, the RAM 403, the HD 404, the HDD controller 405, the display 406, the external device connection I/F 407, the bus line 408, the network I/F 409, the keyboard 410, the pointing device 411, the DVD-RW drive 413, and the media I/F 415, respectively. Accordingly, a redundant description thereof is omitted.

The PC 6 is implemented by a computer, and as illustrated in FIG. 3, includes a CPU 601, a ROM 602, a RAM 603, an HD 604, an HDD controller 605, a display 606, an external device connection I/F 607, a bus line 608, a network I/F 609, a keyboard 610, a pointing device 611, a DVD-RW drive 613, and a media I/F 615. The above-mentioned elements of the PC 6 are substantially the same as the elements of the reservation management server 4, the CPU 401, the ROM 402, the RAM 403, the IM 404, the HDD controller 405, the display 406, the external device connection I/F 407, the bus line 408, the network I/F 409, the keyboard 410, the pointing device 411, the DVD-RW drive 413, and the media I/F 415, respectively. Accordingly, a redundant description thereof is omitted.

Functional Configuration of Management System:

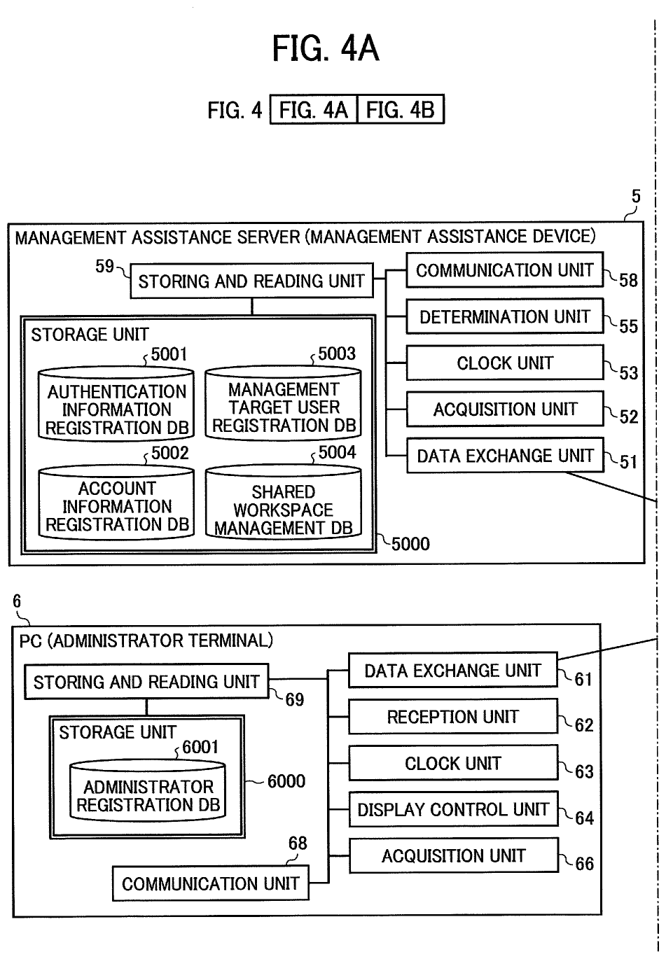

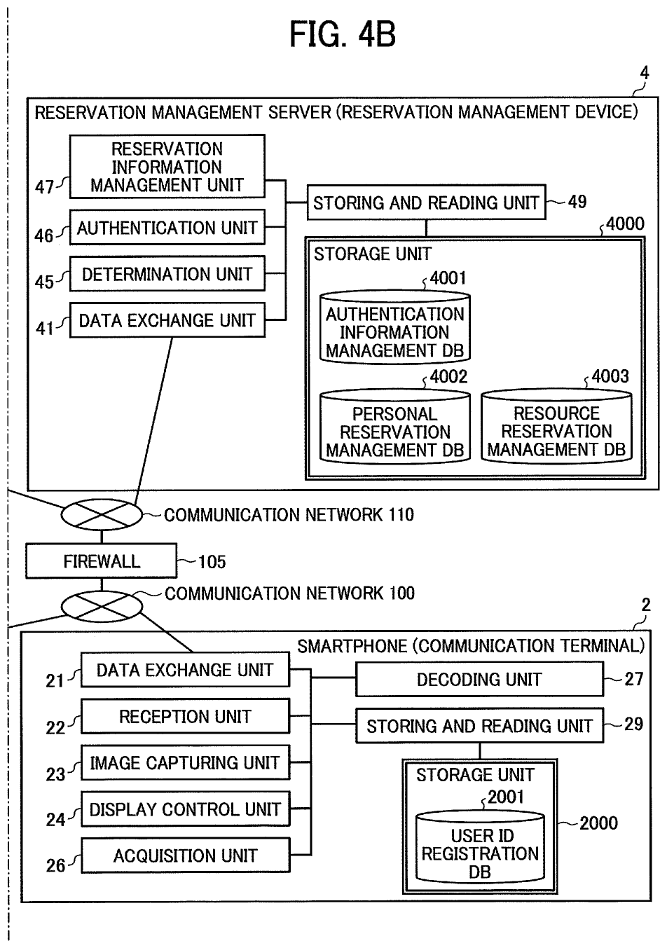

A description is given below of a functional configuration of the management system 1 according to the present embodiment, with reference to FIG. 4 (FIG. 4A and FIG. 4B) to FIG. 10. FIG. 4 (FIG. 4A and FIG. 4B) is a block diagram illustrating an example of the functional configuration of the management system 1 according to the first embodiment of the present disclosure.

Functional Configuration of Smartphone:

As illustrated in FIG. 4B, the smartphone 2 includes a data exchange unit 21, a reception unit 22, an image capturing unit 23, a display control unit 24, an acquisition unit 26, a decoding unit 27, and a storing and reading unit 29. These units are functions that are implemented by or that are caused to function by operating any of the hardware elements illustrated in FIG. 2 in cooperation with instructions of the CPU 201 according to the program dedicated to the smartphone 2 expanded to the RAM 203 from at least one of the ROM 202 and the EEPROM 204.

The smartphone 2 further includes a storage unit 2000 implemented by the ROM 202 or the EEPROM 204 as illustrated in FIG. 2.

User ID Registration Table:

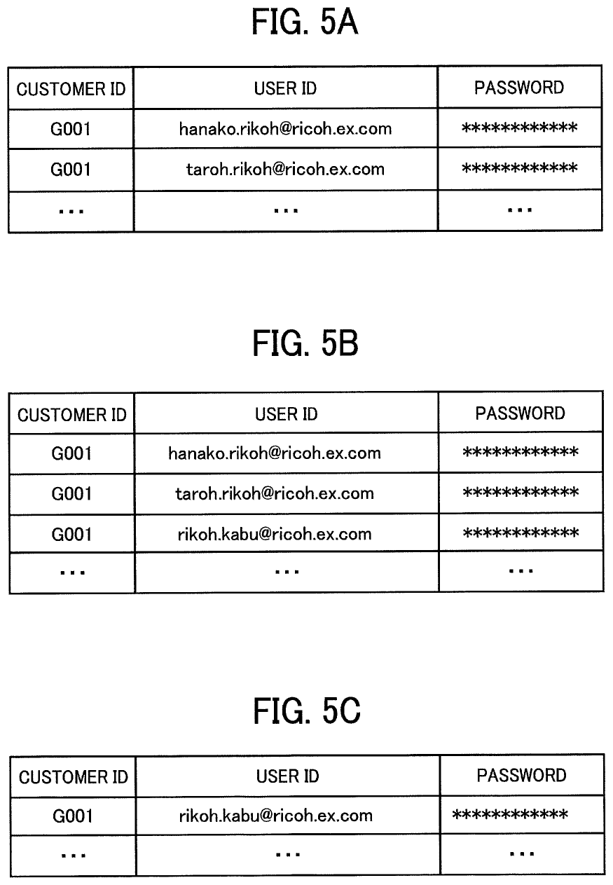

FIG. 5A is a diagram illustrating an example of a user ID registration management table according to the first embodiment. The storage unit 2000 stores a user ID registration database (DB) 2001 including the user ID registration table as illustrated in FIG. 5A. The user ID registration table stores and manages a user ID and a password in association with a corresponding customer ID. The customer ID indicates, for example, identification information for each customer who uses the management system 1 according to the present embodiment.

As the user ID, for example, an e-mail address corresponding to a user, who is managed by using a corresponding customer ID, is stored and managed. “ID” is an abbreviation of identification and means an identifier or identification information. “ID” is any one of a name, a symbol, a character string, a numerical value, or a combination of at least two of these items, which is used to uniquely identifying a specific object among from a plurality of objects. The same applies to other IDs than the user ID. In this embodiment, the user ID is used as an example of user identification information.

The password is identification code information associated with the user ID at a time of log-in. The password is used in using a shared workspace, and a detailed description of this is given later. The password is set by the user when the user installs a chat application or activates (logs in) the chat application the first time.

As for the user ID, for example, when the user successfully be authenticated with respect to the management assistance server 5, this means that the management assistance server 5 has determined that an input user ID is correct. As an account of a reservation-making user who reserved a resource or an account of a user who participate in an event held in relation to the resource, the user ID corresponding to each user is used. Accordingly, the management assistance server 5 is capable of specifying the reservation information related to a user, who inputs the user ID, namely the reservation-making user or a participant, based on the input user ID.

Functional Units of Smartphone:

A detailed description is given below of a functional configuration of the smartphone 2. The data exchange unit 21 of the smartphone 2 illustrated in FIG. 4B is mainly implemented by processing of the CPU 201 illustrated in FIG. 2, the long-range communication circuit 212, and the external device connection OF 219 illustrated in FIG. 2. The data exchange unit 21 transmits or receives various data or various information to or from the reservation management server 4 or the management assistance server 5 via the communication network 100.

The reception unit 22 is mainly implemented by processing of the CPU 201 and processing of the touch panel 221 illustrated in FIG. 2 and receives various selections or inputs performed by the user. In addition to, or in alternative to the touch panel 221, another input device such as an operation key may be used.

The image capturing unit 23 is mainly implemented by processing of the CPU 201 and the imaging element I/F 214 illustrated in FIG. 2, and converts a subjected image captured by the imaging element (CMOS) 213 into an image signal.

The display control unit 24 is mainly implemented by processing of the CPU 201 and the display 218 illustrated in FIG. 2, and causes the display 218 to display various images, characters, code information, or the like.

The acquisition unit 26 is mainly implemented by processing of the CPU 201 illustrated in FIG. 2 and acquires code information based on a subject image captured by the imaging element (CMOS) 213. The subject image includes a two-dimensional code such as QR CODE or one-dimensional code such as a barcode. The acquisition unit 26 further registers the authentication information transmitted from the management assistance server 5 in a storage device.

The decoding unit 27 is mainly implemented by processing of the CPU 201 illustrated in FIG. 2 and decodes identification information associated with a shared workspace or a name of the shared workspace, for example. Such identification information or such a shared workspace name are embedded in code information such as QR CODE of which the image is acquired by the acquisition unit 26.

The storing and reading unit 29 is mainly implemented by processing of the CPU 201 illustrated in FIG. 2 and stores various data (or information) in the storage unit 2000 or reads various data (or information) from the storage unit 2000.

Functional Configuration of Reservation Management Server:

As illustrated in FIG. 4B, the reservation management server 4 includes a data exchange unit 41, a determination unit 45, an authentication unit 46, a reservation information management unit 47, and a storing and reading unit 49. These units are functions that are implemented by or that are caused to function by operating any of the hardware elements illustrated in FIG. 3 in cooperation with instructions of the CPU 401 according to the program dedicated to the reservation management server 4 expanded to the RAM 403 from at least one of the ROM 402 and the HD 404.

The reservation management server 4 further includes a storage unit 4000 implemented by the ROM 402 or the HD 404 illustrated in FIG. 3.

Authentication Information Management Table:

FIG. 5B is a diagram illustrating an example of an authentication information management table according to the first embodiment. The storage unit 4000 stores an authentication information management DB 4001 including the authentication information management table as illustrated in FIG. 5B. The authentication information management table stores and manages a user ID and a password in association with a corresponding customer ID. Since the user ID and the password described above are substantially the same as ones that are used in the user ID registration table illustrated in FIG. 5(A), a redundant description thereof is omitted.

Personal Reservation Management Table:

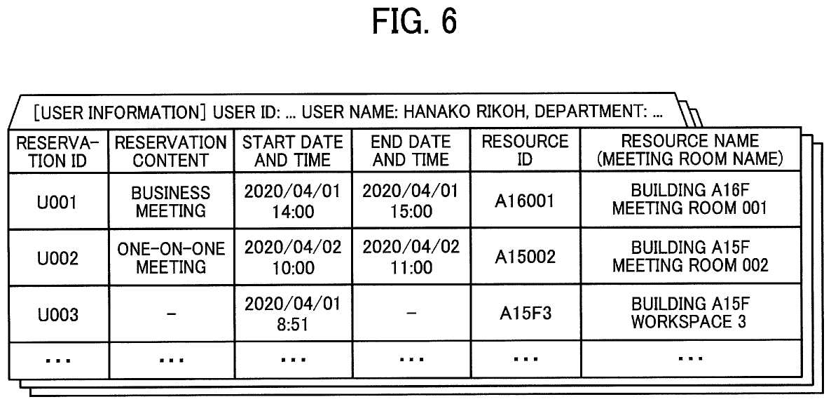

FIG. 6 is a diagram illustrating an example of a personal reservation management table according to the first embodiment. The storage unit 4000 stores a personal reservation management DB 4002 including the personal reservation management table as illustrated in FIG. 6. In the personal reservation management table, user information corresponding to a user is used as a tab. The user information includes a user ID, a user name, and a department to which a corresponding user belongs. The table for each tab includes one or more records to be managed for each reservation ID. Each record corresponding to a reservation ID includes data items of reservation content, start date and time, end date and time, resource ID, and resource name, which are associated with each other. An example of the user ID used as a tab is, for example, hanako.rikoh@ricoh.ex.com.

The reservation content indicates content (an event) to be held in relation to the reservation by the user, and examples of the reservation content includes a meeting, a one-on-one meeting, and the like.

The start date and time is a date and time when the reservation content starts, and the end date and time is a date and time when the reservation content ends.

The resource ID is identification information for identifying a corresponding resource such as a meeting room or a shared workspace and is embedded in a code such as QR CODE or a barcode provided on a corresponding resource. The resource name is a name of a corresponding resource such as a name of a meeting room (meeting room name) or a name of a shared workspace (shared workspace name), for example.

Resource Reservation Management Table:

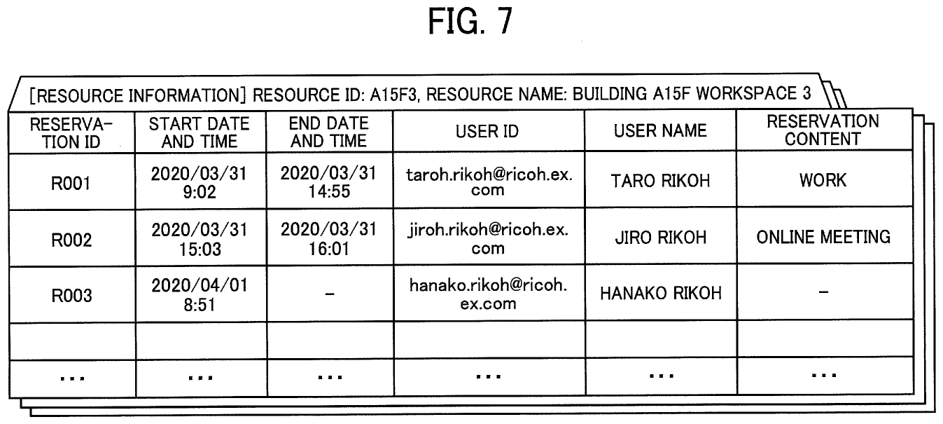

FIG. 7 is a diagram illustrating an example of a resource reservation management table according to the first embodiment. The storage unit 4000 stores a resource reservation management DB 4003 including the resource reservation management table as illustrated in FIG. 7. In the resource reservation management table, a resource name indicating resource information is used as a tab, and each tab includes one or more records to be managed for each reservation ID. Each record corresponding to a reservation ID includes data items of start date and time, end date and time, user ID, user name, and reservation content, which are associated with each other. An example of the resource ID used as a tab is, for example, “A15S3”, and the corresponding resource name is, for example, “Building A 15F workspace 3”.

The start date and time and the end date and time are substantially the same as ones that are described with reference to FIG. 6. In case of usage of the shared workspace, a time at which an image of QR CODE provided in the shared workspace is captured is used as the start date and time, if the resource (shared workspace) is available. As for the end date and time, a work end time may be used if the work end time (or working hours) is obtainable. In addition, when the user of the resource performs a logout process, which is described later in detail, after using the resource, the reservation management server 4 modifies the end date and time in the personal schedule management table, which is described above, with a time of log-out.

The user ID is identification information that identifies a user who uses a resource, and is, for example, an e-mail address of the user.

Functional Units of Reservation Management Server:

A detailed description is given below of a functional configuration of the reservation management server 4. The data exchange unit 41 of the reservation management server 4 illustrated in FIG. 4B is mainly implemented by processing of the CPU 401 illustrated in FIG. 3, the external device connection I/F 407 and the network I/F 409, which are also illustrated in FIG. 3. The data exchange unit 41 transmits or receives various data or various information to or from the management assistance server 5 via the communication network 110 being outside of the firewall 105. The data exchange unit 41 further receives a log-in authentication request or a reservation setting according to one or more user operations performed with the smartphone 2 in using the shared workspace.

The determination unit 45 is mainly implemented by processing of the CPU 401 illustrating in FIG. 3 and makes various determinations in the reservation management server 4.

The authentication unit 46 mainly implemented by processing of the CPU 401 illustrating in FIG. 3 and authenticates the user based on the authentication information (for example, user ID and password) stored in the authentication information DB. An integrated circuit (IC) card or biometric authentication information may be used for the authentication.

The reservation information management unit 47 is mainly implemented by processing of the CPU 401 illustrated in FIG. 3 and manages the reservation information registered by the user. The reservation information management unit 47 reads various reservation information from the personal reservation management DB 4002 and the resource reservation management DB 4003, which are described above, and transmits the various reservation information to the management assistance server 5 via the data exchange unit 41.

The storing and reading unit 49 is mainly implemented by processing of the CPU 301 illustrated in FIG. 3 and stores various data (or information) in the storage unit 4000 or reads various data (or information) from the storage unit 4000.

Functional Configuration of Management Assistance Server:

As illustrated in FIG. 4A, the management assistance server 5 includes a data exchange unit 51, an acquisition unit 52, a clock unit 53, a determination unit 55, a communication unit 58, and a storing and reading unit 59. These units are functions that are implemented by or that are caused to function by operating any of the hardware elements illustrated in FIG. 3 in cooperation with the instructions of the CPU 501 according to the program dedicated to the management assistance server 5 expanded to the RAM 503 from at least one of the ROM 502 and the HD 504. The management assistance server 5 further includes a storage unit 5000 implemented by the ROM 502 or the HD 504 illustrated in FIG. 3.

Authentication Information Registration Table:

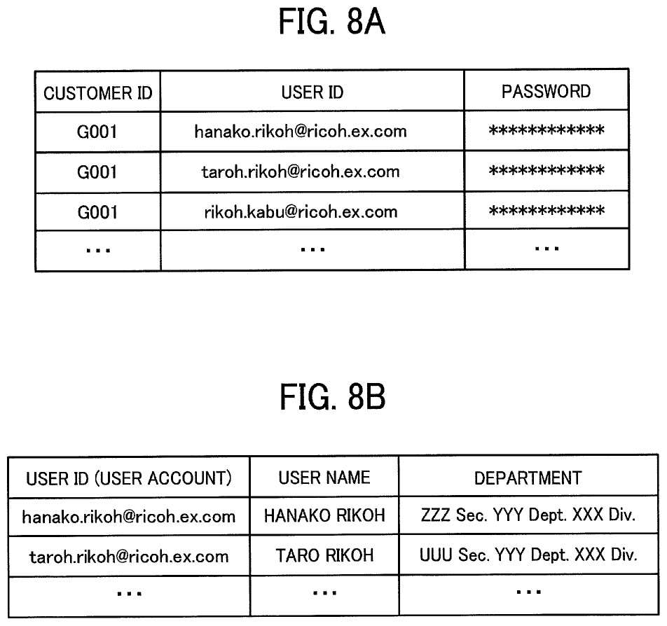

FIG. 8A is a diagram illustrating an example of an authentication information registration table according to the first embodiment. The storage unit 5000 stores an authentication information registration DB 5001 including the authentication information registration table as illustrated in FIG. 8B. The authentication information registration table stores and manages a user ID and a password in association with a corresponding customer ID. Since the user ID and the password described above are substantially the same as ones that are used in the user ID registration table illustrated in FIG. 5(A), a redundant description thereof is omitted.

FIG. 8B is a diagram illustrating an example of the account information management table according to the first embodiment. The storage unit 5000 stores an account information management DB 5002 including the account information management table as illustrated in FIG. 8B. The account information management table stores and manages, for each user ID (account), a user name (username) and a department to which a corresponding user belongs in association with each other. The account is associated with each company or corporation that uses the chat application. In addition, the department indicates to which each user belongs and is a group or an organization managed by the company, corporation, etc. indicated by the customer ID described above. In the present embodiment, the account information management table is used an example of a user information management storage.

Management Target User Registration Table:

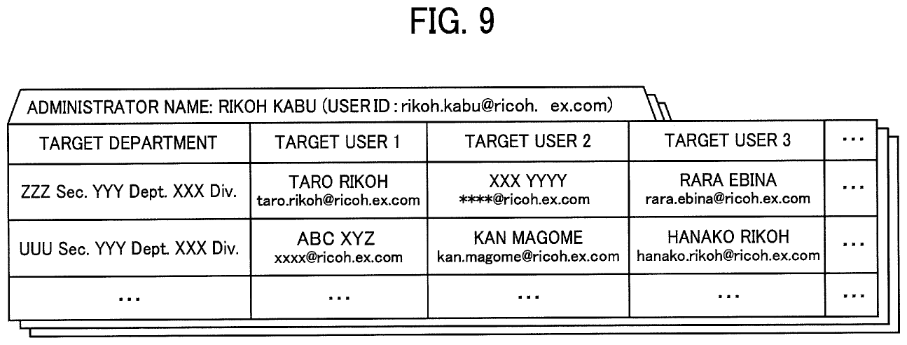

FIG. 9 is a diagram illustrating an example of the management target user registration table according to the first embodiment. The storage unit 5000 stores a management target user registration DB 5003 including the management target user registration table as illustrated in FIG. 9. In the management target user registration table, a name of an administrator who manages users is used as a tab, and each tab includes one or more records to be managed for each management target department. Each record corresponding to a management target department includes data items of management target user 1, management target user 2, management target user 3, (management target user n), . . . , which are associated with each other. An example of the administrator name used as a tab is, for example, “RIKOH KABU”. In the present embodiment, the management target user registration table is used as an example of a management target user information.

The management target department is indicated by a department name and indicates a target department to be managed.

The management target user (target user) includes, for example, an employee assigned in one of management target departments each of which is managed by a corresponding administrator.

In alternative to the management with the management target user registration table, the following method may be used. For example, when the administrator is to obtain a list of possible users whose information may be accessible with administrator authority or a list of users who is related to the department of the administrator as a result of a user search, a predetermined keyword may be transmitted to the reservation management server 4. Alternatively, after the administrator obtains a possible user list, users who are related to the department to which the administrator belongs may be selected from the list, and information on the selected user may be displayed.

Shared Workspace Management Table:

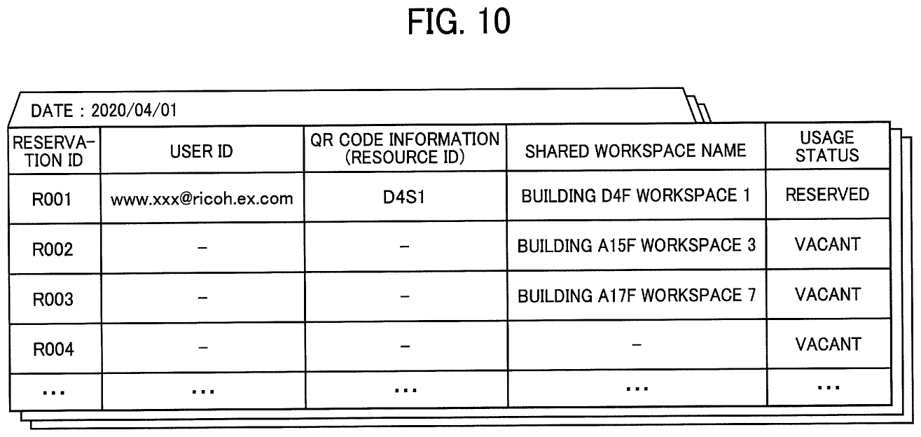

FIG. 10 is a diagram illustrating a shared workspace management table according to the present embodiment. The storage unit 5000 stores a shared workspace management DB 5004 including the shared workspace management table as illustrated in FIG. 10. In the shared workspace management table, a usage date is used as a tab, and each tab includes one or more records to be managed for each reservation ID. Each record corresponding a reservation ID includes data items of user ID, QR CODE information (resource ID), shared workspace name, and usage status, which are associated with each other.

The QR CODE information is information embedded in QR CODE provided on a desk or a wall in the shared workspace, which is one of the resources used by the user. The QR CODE information includes the resource ID. The QR CODE information is registered together with the user ID of User A, which is described in detail later, when an image of QR CODE captured by the smartphone 2 owned or used by User A is transmitted to the management assistant server 5. In the present embodiment, any user among the plurality of users who use the management system 1 is referred to as User A.

The shared workspace name is a name of the shared workspace, and is indicated by, for example, “Building A 15F workspace 3”.

The usage status indicates a usage status of the shared workspace, and is managed as, for example, “RESERVED” if the shared workspace is reserved at a current time, and “VACANT” if the shared workspace is not reserved. Similar to the QR CODE information, the usage status is changed to “RESERVED” to be registered, when an image of QR CODE captured by the smartphone 2 owned or used by User A is transmitted to the management assistant server 5. Further, when a log-out process is performed by User A, the usage status is changed to “VACANT” to be registered.

Functional Units of Management Assistance Server:

A detailed description is given below of a functional configuration of the management assistance server 5. The data exchange unit 51 of the management assistance server 5 illustrated in FIG. 4A is mainly implemented by processing of the CPU 501 illustrated in FIG. 3, the external device connection I/F 507 and the network I/F 509, which are also illustrated in FIG. 3. The data exchange unit 51 transmits or receives various data to or from the reservation management server 4.

The acquisition unit 52 is mainly implemented by processing of the CPU 501 illustrated in FIG. 3 and registers the authentication information (user ID and password, administrator ID and password) transmitted from the smartphone 2 and the PC 6 to the authentication information registration table that is included in the authentication information registration DB 5001.

The clock unit 53 is mainly implemented by processing of the CPU 501 illustrated in FIG. 3 and manages the time information in the management assistance server 5.

The determination unit 55 is mainly implemented by processing of the CPU 501 illustrated in FIG. 3 and makes various determinations in the management assistance server 5.

The communication unit 58 is mainly implemented by processing of the CPU 501 illustrated in FIG. 3, the external device connection I/F 507 and the network I/F 509, which are also illustrated in FIG. 3, and mainly communicates with the reservation management server 4 and other devices.

The storing and reading unit 59 is mainly implemented by processing of the CPU 501 illustrated in FIG. 3 and stores various data (or information) in the storage unit 5000 or reads various data (or information) from the storage unit 5000.

Functional Configuration of PC:

As illustrated in FIG. 4A, the PC 6 includes a data exchange unit 61, a reception unit 62, a clock unit 63, a display control unit 64, an acquisition unit 66, a communication unit 68, and a storing and reading unit 69. These units are functions that are implemented by or that are caused to function by operating any of the hardware elements illustrated in FIG. 3 in cooperation with the instructions of the CPU 601 according to the program dedicated to the PC 6 expanded to the RAM 603 from at least one of the ROM 602 and the HD 604. The PC 6 further includes a storage unit 6000 implemented by the ROM 602 or HD 604 illustrated in FIG. 3.

Administrator ID Registration Table:

FIG. 5C is a diagram illustrating an example of an administrator ID registration table according to the first embodiment. In the storage unit 6000 stores an administrator ID registration DB 6001 including the administrator ID registration table as illustrated in FIG. 5C. The administrator ID registration table stores and manages a user ID and a password in association with a corresponding customer ID.

The user ID is identification information that identifies an administrator who manages users, and is, for example, an e-mail address of the administrator. The password is set by the administrator when the administrator installs a chat application or activates (logs in) the chat application the first time.

Functional Units of PC:

A detailed description is given below of a functional configuration of the PC 6. The data exchange unit 61 of the PC 6 illustrated in FIG. 4A is mainly implemented by processing of the CPU 601 illustrated in FIG. 3, the external device connection I/F 607 and the network I/F 609, which are also illustrated in FIG. 3. The data exchange unit 61 transmits or receives various data to or from the management assistance server 5 through the communication network 100. In the present embodiment, the data exchange unit 61 transmits or receives to or from the management assistance server 5 various information (data) including information on a reservation for each type of resource, information on a resource reservation status associated with a user who uses the resource, information on schedules associated with a user who uses the resource, various information (data) such as information on reservation of various resources, resource reservation status of the user who uses the resource.

The reception unit 62 is mainly implemented by processing of the CPU 601, the keyboard 610, and the pointing device 611 illustrated in FIG. 3 and receives various selections or inputs performed by the administrator. In addition, another input device such as for example a touch panel may be used.

The clock unit 63 is mainly implemented by processing of the CPU 601 illustrated in FIG. 3, and mainly manages the time information in the PC 6.

The display control unit 64 is mainly implemented by processing of the CPU 601 and the display 606 illustrated in FIG. 3, and displays, for example, texts and images represented by various data transmitted from the management assistance server 5.

The acquisition unit 66 is mainly implemented by processing of the CPU 601 illustrated in FIG. 3 and acquires the user information of the user who is authenticated and causes the storing and reading unit 69 to store the user information in a corresponding table (DB).

The communication unit 68 is mainly implemented by processing of the CPU 601 illustrated in FIG. 3, the external device connection I/F 607 and the network I/F 609, which are also illustrated in FIG. 3, and communicates with terminals including the smartphone 2 and various types of devices via the communication network 100 implemented inside the firewall 105. In the above description, the communication unit 68 and the data exchange unit 61 individually have a communication unit. In another example, the communication unit 68 and the data exchange unit 61 share a single communication unit.

The storing and reading unit 69 is mainly implemented by processing of the CPU 601 illustrated in FIG. 3 and stores various data in the storage unit 6000 or reads various data from the storage unit 6000.

Processes or Operation:

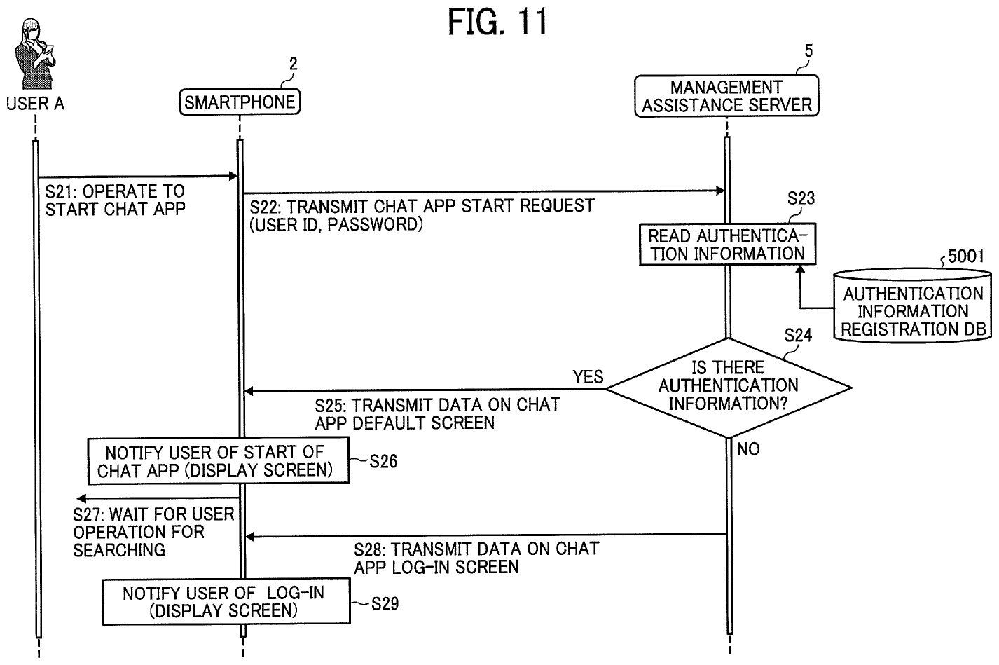

Hereinafter, processes executed in the management system 1 according to the present embodiment is described with reference to FIG. 11 to FIG. 29.

Chat Application Start Process Performed in Response to Operation of User A:

A description is given below of a process from starting the chat application installed on the smartphone 2 to performing an authentication in relation to the reservation management server 4, with reference to FIG. 11. The process is performed in response to a user operation of User A. FIG. 11 is a sequence diagram illustrating an example of chat application initial activation process performed in response to a user operation of User A, according to the first embodiment. In the description of the present embodiment, the chat application using a chatbot is installed on the smartphone 2. However, this is not limiting on the disclosure, another application in alternative to the chat application may be installed on the smartphone to perform substantially the same process.

In order to search for the availability of resources such as meeting rooms and shared workspaces, and in order to reserve a shared workspace, User A activates the chat application installed on the smartphone 2 owned or used by User A. Accordingly, the reception unit 22 of the smartphone 2 accepts the activation process of the chat application performed in response to the user operation of User A (step S21).

Upon receiving the user operation for the start process for the chat application, the data exchange unit 21 that also communicates with the chat application transmits a start request to the management assistance server 5 (step S22). Accordingly, the data exchange unit 51 of the management assistance server 5 receives the start request transmitted from the smartphone 2.

Then, the storing and reading unit 59 reads a corresponding password by searching the authentication information management table (see FIG. 8A) by using the user ID as a search key (step S23).

Subsequently, the determination unit 55 determines whether the start request transmitted from the smartphone 2 includes the authentication information (step S24).

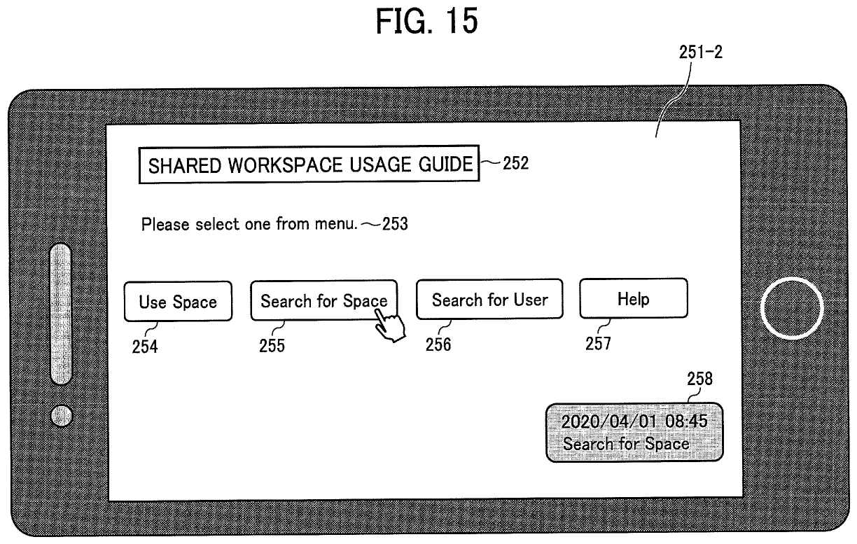

When the determination unit 55 determines that the authentication information is included (step S24: YES), the data exchange unit 51 transmits to the smartphone 2 screen information for displaying a chat application screen 251-2 as illustrated in FIG. 15 (step S25). Accordingly, the data exchange unit 21 of the smartphone 2 receives the screen information transmitted from the management assistance server 5.

When the data exchange unit 21 receives the screen information for displaying the chat application screen 251-2, the display control unit 24 causes the display 218 to display the chat application screen 251-2, which may be a default screen, as illustrated in FIG. 15 (step S26). After that, the reception unit 22 waits for a user operation of User A performed with respect to the chat application screen 251-2 as illustrated in FIG. 15 (step S27).

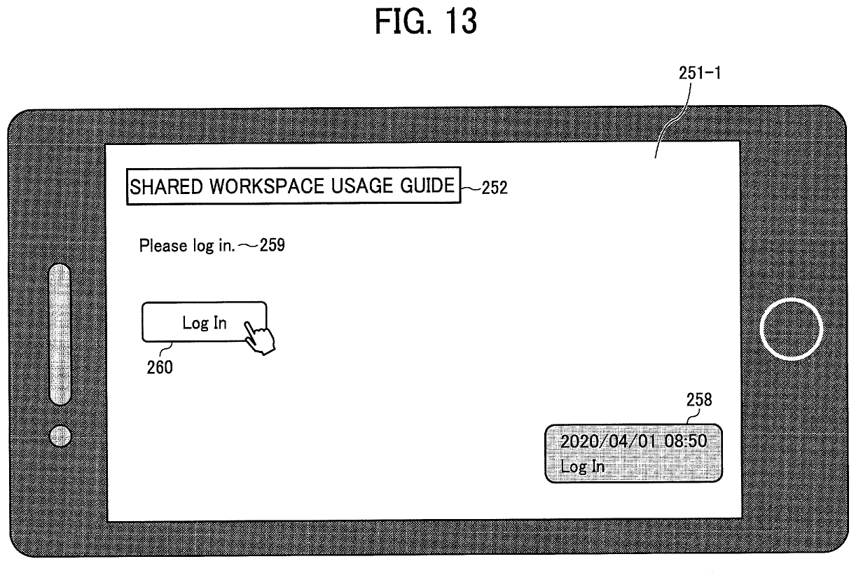

On the other hand, when the determination unit 55 determines that the authentication information is not present (not included) (step S24: NO), the data exchange unit 51 transmits to the smartphone 2 screen information for displaying a chat application screen 251-1 that includes a “Log In” button 260 as illustrated in FIG. 13 (step S28). Accordingly, the data exchange unit 21 of the smartphone 2 receives from the management assistance server 5 the screen information for displaying the chat application screen 251-1 including the “Log In” button 260. The chat application screen 251-1 may be referred to as a chat application log-in screen. That is, the data exchange unit 51 transmits to the smartphone 2 the screen information prompting User A to logs in.

When the data exchange unit 21 receives the screen information for displaying the chat application screen 251-1 including the “Log In” button 260, the display control unit 24 causes the display 218 to display the chat application screen 251-1, which prompt a user to logs in, as illustrated in FIG. 13 (step S29).

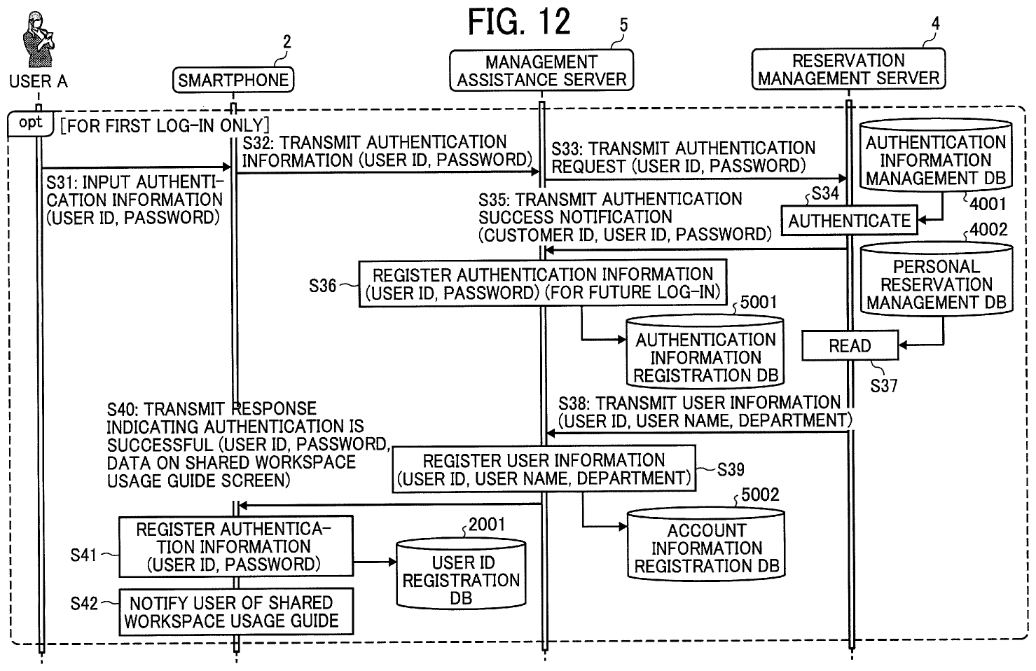

User A performs a user operation such as pressing, clicking, or tapping the “Log In” button 260 to perform a login process as illustrated in FIG. 12, and inputs the authentication information that includes the user ID and the password. By performing the series of processes as described above, the determination unit 55 of the management assistance server 5 determines whether the authentication in relation to User A is performed the first time or not. Accordingly, that start process and the authentication process for the chat application with the smartphone 2 are performed.

Log-In Process Corresponding to User A (First Log-In Only):

A description is given below of a process of performing an authentication that is for the first login for the chat application, and the process is performed in response to a user operation of User A, with reference to FIG. 12. The process for the authentication, which is for the first log-in for the chat application, may be referred to as an initial authentication process, hereinafter. FIG. 12 is a sequence diagram illustrating an example of chat application initial authentication process performed in response to a user operation of User A, according to the first embodiment. When the above-mentioned processing of S21 to S28 is performed in the management system 1, the reception unit 22 of the smartphone 2 accepts the input of the authentication information from User A (step S31). The authentication information includes the user ID and the password of User A.

Then, the data exchange unit 21 transmits the authentication information (user ID and password) input by User A to the management assistance server 5 (step S32). Accordingly, the data exchange unit 51 of the management assistance server 5 receives the authentication information (user ID and password) transmitted from the smartphone 2.

The data exchange unit 51 that has received the authentication information from the smartphone 2 transmits an authentication request including the user ID and the password to the reservation management server 4 (step S33). Accordingly, the data exchange unit 41 of the reservation management server 4 receives the authentication request including the user ID and the password transmitted from the management assistance server 5.

The authentication unit 46 of the reservation management server 4 that has received the authentication request searches the authentication management table included in the authentication information management DB 4001 by using a set of the user ID the password as a search key to read a corresponding set of the user ID and the password to perform an authentication (step S34).

When the authentication process is successful, the data exchange unit 41 transmits an authentication success notification to the management assistance server 5 (step S35). This authentication success notification includes the user ID and the password used for the authentication process. Accordingly, the data exchange unit 51 of the management assistance server 5 receives the authentication success notification transmitted from the reservation management server 4.

Subsequently, the acquisition unit 52 of the management assistance server 5 registers the authentication information (user ID and password) received by the data exchange unit 51 in the authentication information registration table included in the authentication information registration DB 5001 (step S36).

Subsequently, the storing and reading unit 49 of the reservation management server 4 searches the personal reservation management table (see FIG. 6) managed for each user ID as the tab, by using the user ID received in step S33 as a search key to read a corresponding user ID (account) and a corresponding department to which the user belongs (department information) (step S37).

Then, the data exchange unit 41 transmits information read in S37 to the management assistance server 5 (step S38). The information is namely user information that indicates the user ID, the user name, and the department to which the user belongs. Accordingly, the data exchange unit 51 of the management assistance server 5 receives from the reservation management server 4 the information items indicating the user ID, the user name, and the department to which the user belongs.

Subsequently, the acquisition unit 52 registers in the account management table each of the information items indicating the user ID, the user name, and the department to which the user belongs included in the information received by the data exchange unit 51 (see FIG. 8B) (step S39).

After the information is registered in the account management table in step S39, the data exchange unit 51 transmits to the smartphone 2 data on a shared workspace usage guide screen (shared workspace usage guide screen data) in addition to the user ID and the password, which is associated with User A (step S40). Accordingly, the data exchange unit 21 of the smartphone 2 receives the user ID and the password, which is associated with User A, and the shared workspace usage guide screen data transmitted from the management assistance server 5.

Then, the acquisition unit 26 of the smartphone 2 registers the user ID and the password in the user ID registration table (see FIG. 5A) as the user information of the authenticated user, User A. (step S41).

After that, the display control unit 24 causes the display 218 to display the shared workspace usage guide screen, which is described later in detail, to notify User A of the shared workspace usage guide (step S42). In addition to the display the screen on the display 218, the notification may be provided by voice sound via the speaker 216.

Example Screen:

FIG. 13 is a diagram illustrating an example of a log-in screen displayed with a communication terminal owned or used by User A according to the first embodiment. As illustrated in FIG. 13, when the processing of step S31 described above is performed, the display control unit 24 causes the display 218 of the smartphone 2 to display the chat application screen 251-1 that includes, for example, a display part of “SHARED WORKSPACE USAGE GUIDE” 252, a message of “Please log in.” 259, the “Log In” button 260, and a text display field 258. At this time, in the text display field 258, “2020/04/01 08:50”, which indicates the current date and time and, “Log In” are displayed, for example. Accordingly, User A performs a user operation such as pressing, clicking, or tapping, with respect to the “Log In” button 260 to execute the log-in process.

Workspace Search Process According to User Operation:

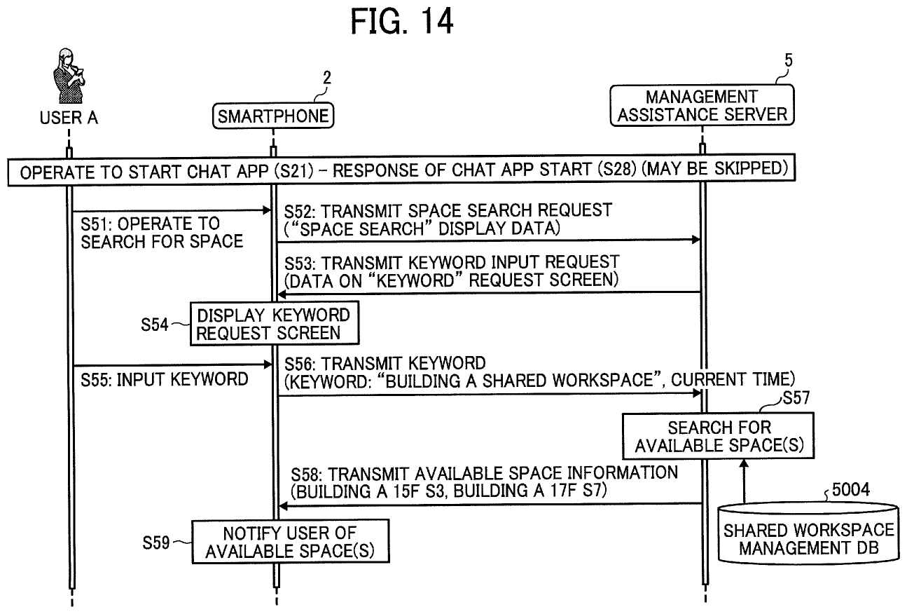

A description is given below of a process of searching for a workspace (workspace search process, space search process) performed according to user operations of User A, with reference to FIG. 14. FIG. 14 is a sequence diagram illustrating an example of workspace search process performed according to user operations of User A, according to the first embodiment. At this time, when the workspace search process is following to the above-described initial authentication process, the processing from operating to start the chat application (application activation process) (step S21) to starting the chat application (start response) (step S28) may be skipped.

First, User A of the smartphone 2 presses, clicks, or taps a “Search for Space” button 255 from a menu selection screen displayed on the chat application screen 251-2 illustrated in FIG. 15, which is described in detail later. Accordingly, the reception unit 22 of the smartphone 2 accepts a space search request (shared workspace search request, workspace search request) (step S51).

Then, the data exchange unit 21 transmits to the management assistance server 5 the space search request in response to the user operation performed with respect to the “Search for Space” button 255 (step S52). Accordingly, the data exchange unit 51 of the management assistance server 5 receives the space search request transmitted from the smartphone 2.

After the processing of step S52 is performed, the data exchange unit 51 transmits a keyword input request to the smartphone 2 (step S53). Accordingly, the data exchange unit 21 of the smartphone 2 receives the keyword input request transmitted from the management assistance server 5.

Then, the display control unit 24 causes the display 218 of the smartphone 2 to display a keyword request screen (step S54).

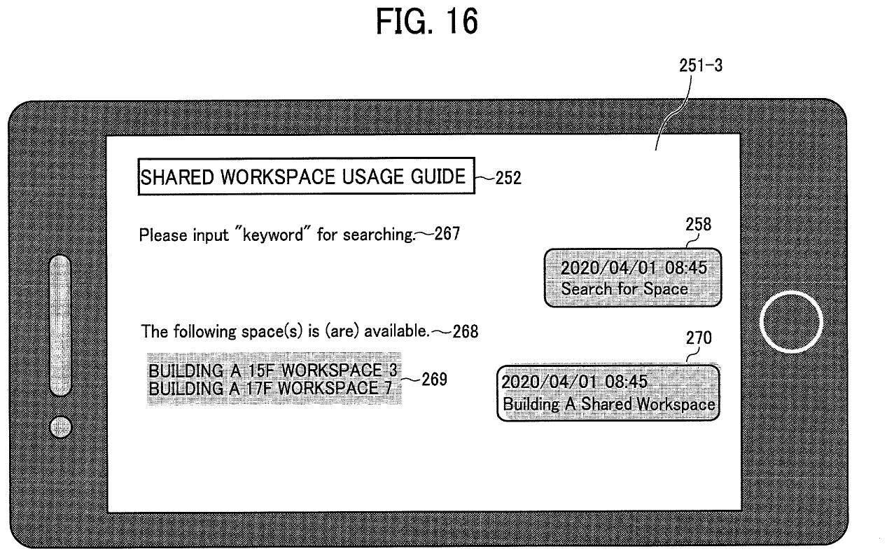

When confirming that the keyword request screen is displayed on the display 218 of the smartphone 2, User A performs a keyword input operation on the display 218. Accordingly, the reception unit 22 of the smartphone 2 receives the input operation (step S55). In the description of the present embodiment, for example, as illustrated in FIG. 16, “Building A Shared Workspace” is input in a “text input” field 270, which is described later in detail. A detailed description of the screen is given later with an example screen.

Then, the data exchange unit 21 transmits to the management assistance server 5 information indicating “Building A Shared Workspace” received as a keyword, and information on a current time indicated by the smartphone 2 (step S56). The information on a current time may be referred to as current time information, hereinafter. Accordingly, the data exchange unit 51 of the management assistance server 5 receives the information indicating “Building A Shared Workspace” and the current time information indicating the current time indicated by the smartphone 2, which are transmitted from the smartphone 2. As for the current time, time information managed by the clock unit 53 of the management assistance server 5 may be used. In that case, the current time information is not received in step S56.

Upon receiving the keyword in step S56, the management assistance server 5 performs search for one or more available spaces (available shared workspaces). Specifically, the storing and reading unit 59 searches the shared workspace management table (see FIG. 10) by using the “Building A Shared Workspace” indicated by the received keyword as a search key to read a usage status of a corresponding shared workspace (step S57).

At this time, the determination unit 55 determines whether a usage status of a shared workspace read by the storing and reading unit 59 is “VACANT” or not at the current time. The determination unit 55 determines that the shared workspace of which the usage status is “VACANT” is an available space and transmits a determination result including available space information indicating one or more available spaces to the smartphone 2 via the data exchange unit 51 (step S58). Accordingly, the data exchange unit 21 of the smartphone 2 receives the available space information transmitted from the management assistance server 5. In the description of the present embodiment, for example, the available space information indicates “BUILDING A 15F WORKSPACE 3” and “BUILDING A 17F WORKSPACE 7”. In the processing of step S58, as resource name information included in the available space information, which is the determination result, a name of the shared workspace of which the usage status is currently “VACANT” is used. That is, the resource name information indicates a name of a resource that has not reserved by User A.

The display control unit 24 of the smartphone 2 that has received the available space information including, for example, the resource name information from the management assistance server 5 causes the display 218 to display a chat application screen 251-3 to notify User A of the available spaces, as illustrated in FIG. 16 (step S59). As a result, User A is notified of “BUILDING A 15F WORKSPACE 3” and “BUILDING A 17F WORKSPACE 7” as the available shared workspaces at the current time.

Example Screen:

FIG. 15 is a diagram illustrating an example of a workspace search screen displayed with a communication terminal owned or used by User A according to the first embodiment. As illustrated in FIG. 15, when the processing of step S51 described above is performed, the display control unit 24 causes the display 218 of the smartphone 2 to display the chat application screen 251-2 that includes, for example, the display part of “SHARED WORKSPACE USAGE GUIDE” 252, a message of “Please select one from menu.” 253, a “Use Space” button 254, a “Search for Space” button 255, a “Search for User” button 256, a “Help” button 257, and the text display field 258. At this time, in the text display field 258, “2020/04/01 08:45”, which indicates the current date and time, and “Search for Space” are displayed.

FIG. 16 is a diagram illustrating another example of a workspace search screen displayed with a communication terminal owned or used by User A according to the first embodiment. As illustrated in FIG. 16, when the processing of step S54 described above is performed, the display control unit 24 causes the display 218 of the smartphone 2 to display a chat application screen 251-3 that includes, for example, the display part of “SHARED WORKSPACE USAGE GUIDE” 252, a message of “Please input “keyword” for searching.” 267, and the text display field 258. At this time, in the text display field 258, “2020/04/01 08:45”, which indicates the current date and time, and “Search for Space” are displayed. After that, when User A inputs “Building A Shared Workspace” in the text input field 270, the display control unit 24 displays a message of “The following space(s) is(are) available.” 268, and information on one or more available spaces (resources). For example, as the information on one or more available spaces (resources), information on “BUILDING A 15F WORKSPACE 3” and “BUILDING A 17F WORKSPACE 7” 269 is displayed in two columns as illustrated in FIG. 16. At this time, in the “text input” field 270, “2020/04/01 08:45”, which indicates the current date and time, and text of “Building A Shared Workspace”, which has been input by User A, are displayed.

QR CODE Reading Process:

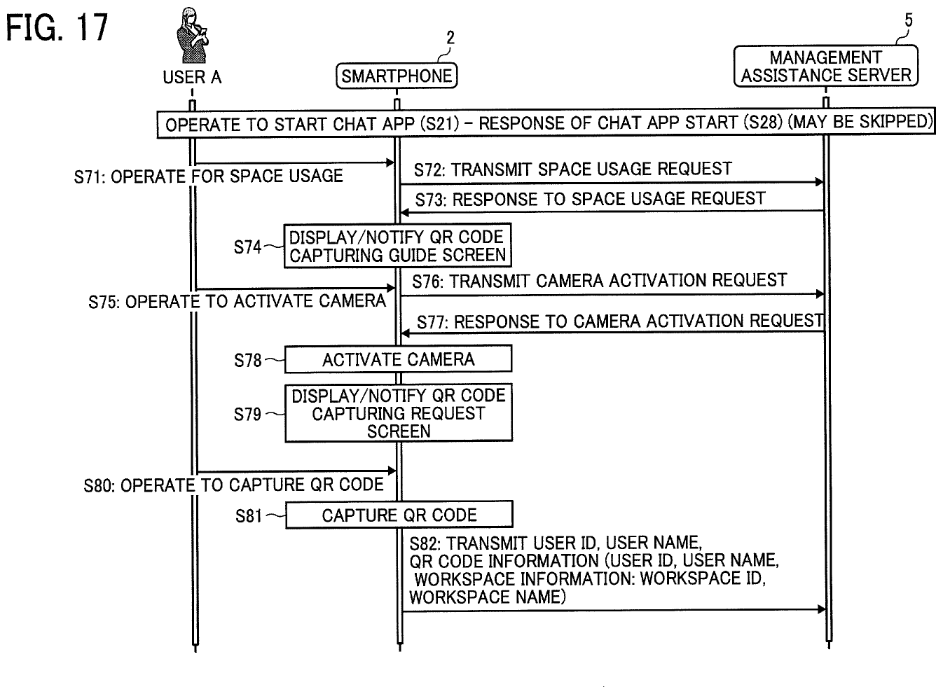

A description is given below of a process of reading QR CODE provided in a shared workspace, performed by the smartphone 2. FIG. 17 is a sequence diagram illustrating an example of a camera activation process and a QR CODE capturing process, performed according to user operations of User A, according to the first embodiment. When the application activation process and the authentication process have already been completed according to the user operations of User A, the processing from steps S21 to S28 is skipped.

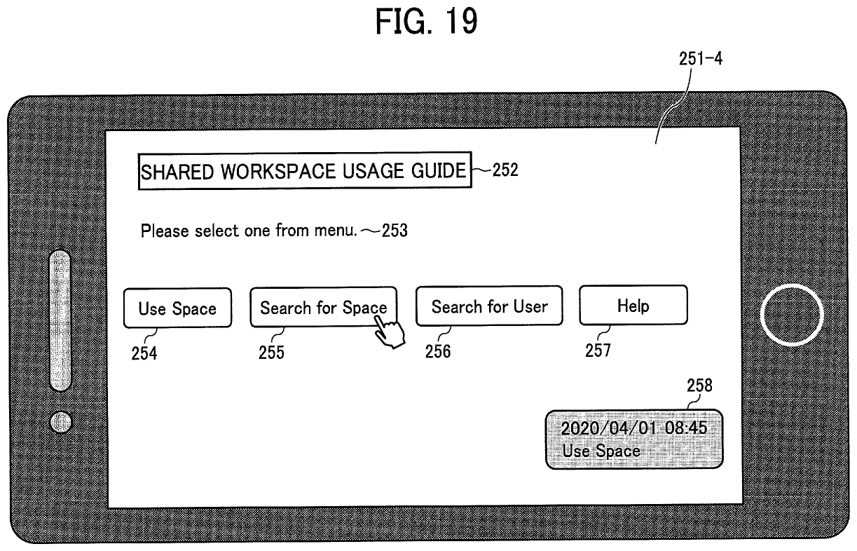

User A operates the smartphone 2, for example, clicks or taps, the “Use Space” button 254 on a chat application screen 251-4 as illustrated in FIG. 19, which is described in detail later. Accordingly, the reception unit 22 of the smartphone 2 receives the user operation performed by User A (step S71).

After receiving the user operation performed by User A, the data exchange unit 21 transmits a workspace usage request to the management assistance server 5 (step S72). Accordingly, the data exchange unit 51 of the management assistance server 5 receives the workspace usage request transmitted from the smartphone 2.

The data exchange unit 51 of the management assistance server 5 that has received the workspace usage request transmits a QR CODE capturing request to the smartphone 2 as a response to the workspace usage request (step S73). Accordingly, the data exchange unit 21 of the smartphone 2 receives the QR CODE capturing request, which is used as the response to the workspace usage request, transmitted from the management assistance server 5.

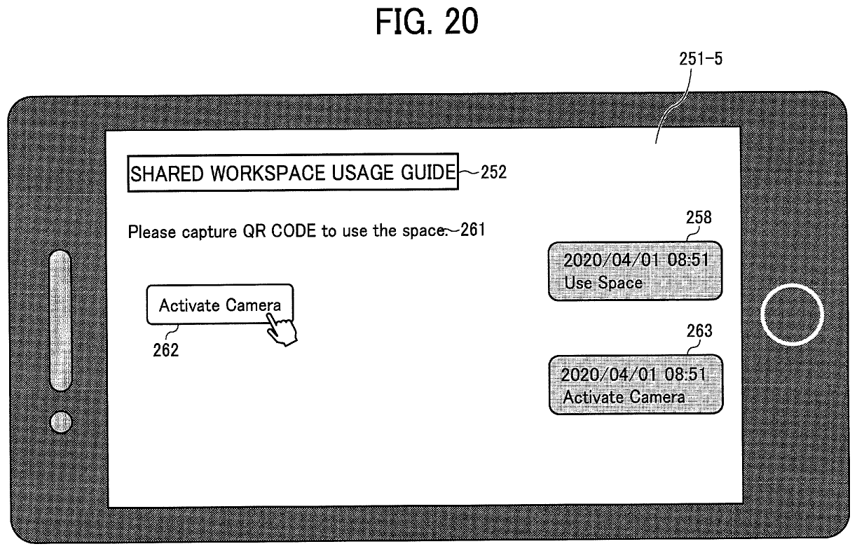

Then, the display control unit 24 causes the display 218 to display a QR CODE capturing guide as illustrated in FIG. 20, which is described in detail later (step S74).

After confirming the display in step S74, User A activates the camera, namely User A performs a user operation for activating the camera (camera activation operation). Accordingly, the reception unit 22 of the smartphone 2 receives the camera activation operation (step S75).

The smartphone 2 that has received the camera activation operation transmits a camera activation request from the data exchange unit 21 to the management assistance server 5 (step S76). Accordingly, the data exchange unit 51 of the management assistance server 5 receives the camera activation request transmitted from the smartphone 2.

The data exchange unit 51 of the management assistance server 5 that has received the camera activation request transmits a response to the camera activation request to the smartphone 2 (step S77). Accordingly, the data exchange unit 21 of the smartphone 2 receives the response to the camera activation request from the management assistance server 5. That is, reading of QR CODE is performed according to an instruction from the management assistance server 5.

Then, the image capturing unit 23 of the smartphone 2 controls the imaging element I/F 214 and activates the camera (step S78).

The display control unit 24 further causes the display 218 to display a QR CODE shooting request screen (step S79). Specifically, a QR CODE capturing guide screen as illustrated in FIG. 20, which is described above, is displayed.

User A who confirms the QR code capturing guide screen operates the smartphone 2 to capture QR CODE. That is, the reception unit 22 receives a QR CODE capturing operation performed by User A (step S80).

Then, the image capturing unit 23 captures an image of QR CODE provided in a certain shared workspace A according to the user operation performed by User A (step S81). QR CODE may be sticked on a part of the shared workspace A, for example.

After the image of QR CODE is captured, the data exchange unit 21 transmits to the management assistance server 5 information on the user ID and the user name corresponding to User A and the resource ID and the resource name corresponding to the shared workspace A. The resource ID and the resource name are embedded in QR CODE (step S82). Accordingly, the data exchange unit 51 of the management assistance server 5 receives the information on the user ID and the user name corresponding to User A and the resource ID and the resource name corresponding to the shared workspace A, which are transmitted from the smartphone 2. The resource ID and the resource name have been read from QR CODE. In the present embodiment, the ID of the shared workspace A is used as an example of the resource identification information (resource ID).

In the management system 1 according to the present embodiment, when the processing of step S82 described above is performed, another device may be between the smartphone 2 (communication terminal) and the management assistance server 5 (management assistance device). That is, the information transmitted from the smartphone 2 may be transmitted to the management assistance server 5 via another device.

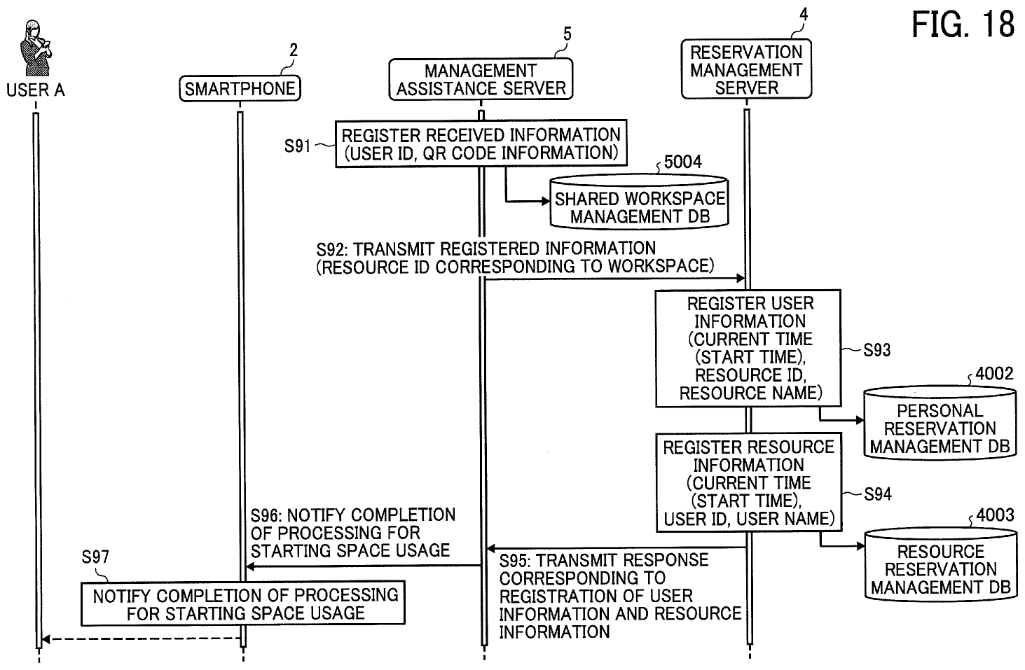

FIG. 18 is a sequence diagram illustrating an example of a process for workspace usage, performed according to user operations of User A, according to the first embodiment. The storing and reading unit 59 of the management assistance server 5 registers the user ID, the resource ID (shared workspace identification (ID)) used as QR CODE information, and the shared workspace name, which are received from the smartphone 2, in the shared workspace management table (see FIG. 10) (step S91). The storing and reading unit 59 further changes a usage status corresponding to a reservation ID that is registered in step S91 in the shared workspace management table from “VACANT” to “RESERVED”. In addition, with respect to the resources managed by the reservation management server 4, the user ID, the QR CODE information, etc. registered in the shared workspace management table (see FIG. 10) in step S91 described above may be used for a subsequent determination performed in the logout process.

Then, after registering the resource ID corresponding to the shared workspace A, the data exchange unit 51 transmits to the reservation management server 4 the resource ID corresponding to the shared workspace A (step S92). Accordingly, the data exchange unit 41 of the reservation management server 4 receives the resource ID transmitted from the management assistance server 5. In the management system 1 according to the present embodiment, another device may be between the management assistance server 5 and the reservation management server 4. That is, the resource ID transmitted by the management assistance server 5 may be received once by another device, and then the resource ID may be transmitted from the other device to the reservation management server 4.

After receiving the resource ID transmitted from the management assistance server 5, the storing and reading unit 59 registers the user information in the personal reservation registration table (see FIG. 6). The information to be registered includes the current time (start date and time), the resource ID, and the resource name (step S93). When making a reservation for the shared workspace A, User A may input the reservation content for the personal reservation management table.

After registering the user information, the storing and reading unit 49 registers the resource information in the resource reservation management table (see FIG. 7). The information to be registered includes the current time (start date and time), the user ID, and the user name (step S94). When making a reservation for the shared workspace A, User A may input the reservation content for the resource reservation management table as well as the case of the registration of the user information for the personal reservation management table. In addition, an end date and time may be an arbitrary time input by User A, or the reservation management server 4 may set the end date and time by taking into account the working hours of User A.

After performing the processing of steps S93 and S94, the data exchange unit 41 transmits a response corresponding to the registration of the user information and the resource information to the management assistance server 5 (step S95). Accordingly, the data exchange unit 51 of the management assistance server 5 receives the response corresponding to the registration of the user information and the resource information transmitted from the reservation management server 4.

Then, the data exchange unit 51 transmits a notification of the completion of processing for starting space usage to the smartphone 2 (step S96). Accordingly, the data exchange unit 21 of the smartphone 2 receives the notification of the completion of processing for starting space usage transmitted from the management assistance server 5.

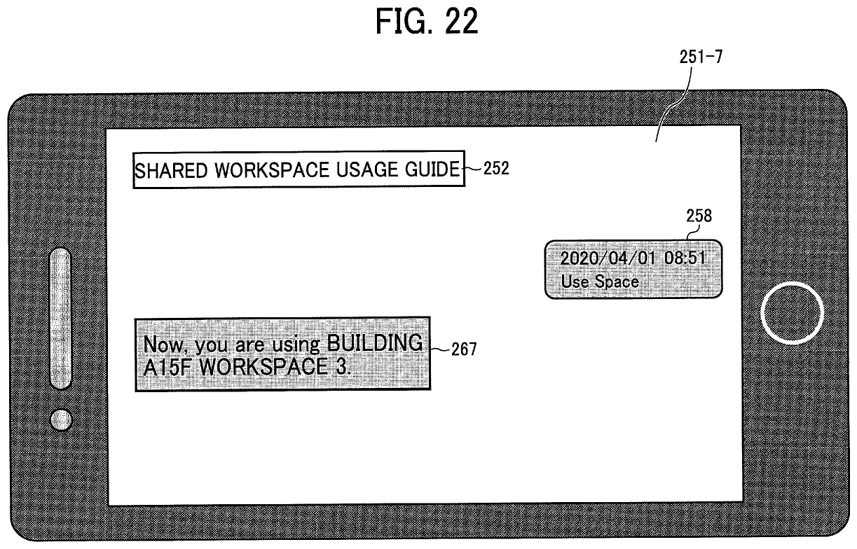

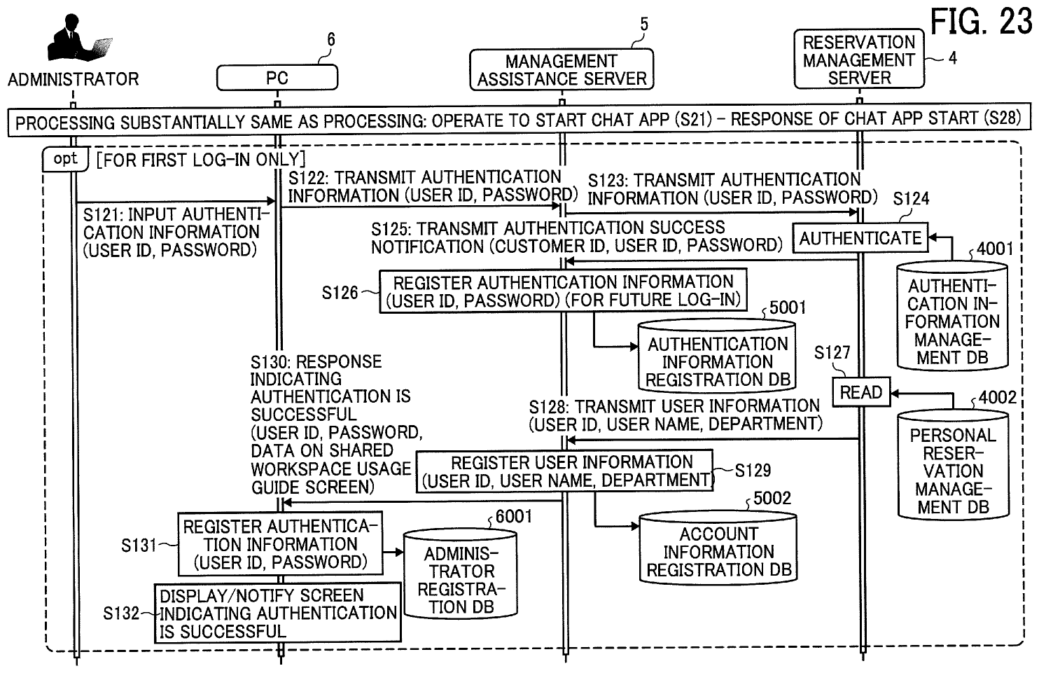

After receiving the notification of the completion of processing for starting space usage in step S96, the display control unit 24 causes the display 218 to display a chat application startup screen 251-7 as illustrated in FIG. 22 on as the workspace usage completion notification (step S97).

Example Screen:

FIG. 19 is a diagram illustrating an example of a workspace usage screen displayed with a communication terminal owned or used by User A according to the first embodiment. As illustrated in FIG. 19, when the processing of steps S71 to S73 described above is performed, the display control unit 24 causes the display 218 of the smartphone 2 to display the chat application screen 251-4 that includes, for example, the display part of “SHARED WORKSPACE USAGE GUIDE” 252, the message of “Please select one from menu.” 253, the “Use Space” button 254, the “Search for Space” button 255, the “search for User” button 256, the “Help” button 257, and the text display field 258. At this time, in the text display field 258, “2020/04/01 08:50”, which indicates the current date and time, and “Use Space” are displayed.

FIG. 20 is a diagram illustrating an example of a camera activation screen displayed with a communication terminal owned or used by User A according to the first embodiment. As illustrated in FIG. 20, when the processing of steps S75 to S78 described above is performed, the display control unit 24 causes the display 218 of the smartphone 2 to display a chat application screen 251-5 that includes, for example, the display part of “SHARED WORKSPACE USAGE GUIDE” 252, a message of “Please capture QR CODE to use the space.” 261, the text display field 258, a text display field including “Activate Camera” 263, and an “Activate Camera” button 262. At this time, in the text display field 258, “2020/04/01 08:51”, which indicates the current date and time, and “Use Space” are displayed. Further, in the text display field 263, “2020/04/01 08:51”, which indicates the current date and time, and “Activate Camera” are displayed.

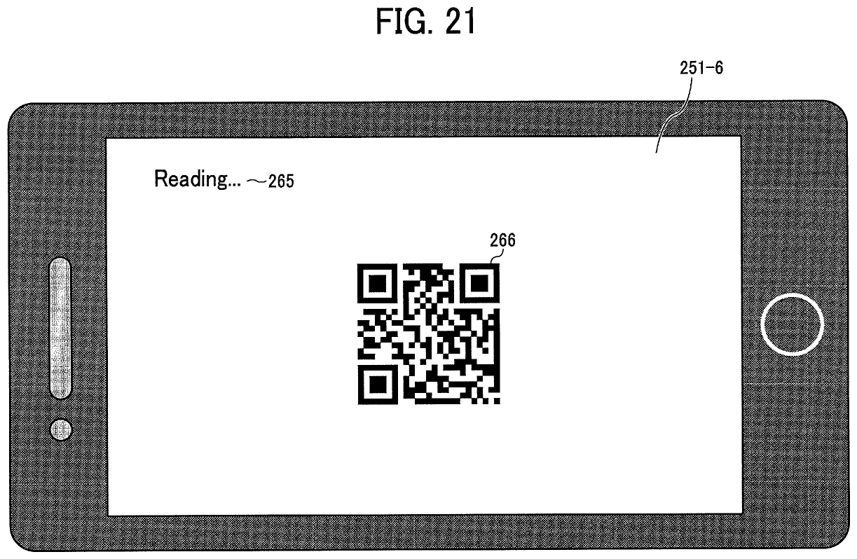

FIG. 21 is a diagram illustrating an example of a QR CODE reading screen displayed with a communication terminal owned or used by User A according to the first embodiment. As illustrated in FIG. 21, the display control unit 24 causes the display 218 of the smartphone 2 to display a chat application screen 251-6 that includes a message of “Reading . . . ” 265 indicating that QR CODE is being read and an image of QR CODE 266.

FIG. 22 is a diagram illustrating another example of a workspace usage screen displayed with a communication terminal owned or used by User A according to the first embodiment. As illustrated in FIG. 22, when the processing of steps S80 to S96 described above is performed, the display control unit 24 causes the display 218 of the smartphone 2 to display the chat application screen 251-7 that includes, for example, the display part of “SHARED WORKSPACE USAGE GUIDE” 252, the text display field 258, and a message indicating use of the workspace has been started 267. For example, the message indicating use of the workspace has been started 267 is “Now, you are using BUILDING A 15F WORKSPACE 3”. At this time, in the text display field 258, “2020/04/01 08:51”, which indicates the current date and time, and “Use Space” are displayed.

Chat Application Start Process Performed in Response to Operation of Administrator:

A description is given below of a process of searching for a space performed according to user operations of the administrator who manages User A, with reference to FIG. 23. FIG. 23 is a sequence diagram illustrating an example of chat application initial activation process and an authentication process performed according to user operations of the 3 0 administrator, according to the first embodiment. Since the chat application activation process and the authentication process performed in response to the user operations of the administrator are substantially the same as the chat application activation process and the authentication process performed in response to the user operation of User A, a detailed description thereof is omitted.

Log-In Process Corresponding to Administrator (First Log-In Only):

A description is given below of a process of starting the chat application the first time (chat application initial activation process) and a process of performing an authentication (authentication process) that are performed according to user operations of the administrator who manages User A (hereinafter may be referred to as a manager), with reference to FIG. 23. FIG. 23 is a sequence diagram illustrating an example of chat application initial activation process and an authentication process performed according to user operations of the administrator, according to the first embodiment. Since the processing from the chat application activation process to the log-in notification performed in response to a user operation of the administrator is substantially the same as the chat application activation process performed in response to User A (see FIG. 11), a detailed description thereof is omitted.

The reception unit 62 of the PC 6 receives the input of the authentication information from the administrator (step S121). This authentication information includes the user ID and the password of the administrator.

Then, the data exchange unit 61 transmits the authentication information (user ID and password) input by the administrator to the management assistance server 5 (step S122). Accordingly, the data exchange unit 51 of the management assistance server 5 receives the authentication information (user ID and password) transmitted from the smartphone 2.

The data exchange unit 51 that has received the authentication information from the smartphone 2 transmits an authentication request including the user ID and the password to the reservation management server 4 (step S123). Accordingly, the data exchange unit 41 of the reservation management server 4 receives the authentication request including the user ID and the password transmitted from the management assistance server 5.

The authentication unit 46 of the reservation management server 4 that has received the authentication request searches the authentication management table included in the authentication information management DB 4001 by using a set of the user ID the password as a search key, and reads a corresponding set of a user ID and a password to perform the authentication (step S124).

When the authentication process is successful, the data exchange unit 41 transmits an authentication success notification to the management assistance server 5 (step S125). This authentication success notification includes the user ID and the password used for the authentication process. Accordingly, the data exchange unit 51 of the management assistance server 5 receives the authentication success notification transmitted from the reservation management server 4.

Subsequently, the acquisition unit 52 of the management assistance server 5 registers the authentication information (user ID and password) received by the data exchange unit 51 in the authentication information registration table included in the authentication information registration DB 5001 (step S126).

Subsequently, the storing and reading unit 49 of the reservation management server 4 searches the personal reservation management table (see FIG. 6) managed for each user ID as the tab, by using the user ID received in step S123 as a search key to read a corresponding user ID (account) and a corresponding department to which the user belongs (step S127).

Then, the data exchange unit 41 transmits information read in S127 to the management assistance server 5 (step S128). The information is namely user information that indicates the user ID, the user name, and the department to which the user belongs. Accordingly, the data exchange unit 51 of the management assistance server 5 receives from the reservation management server 4 the information items indicating the user ID, the user name, and the department to which the user belongs.

Subsequently, the acquisition unit 52 registers in the account management table each of the information items indicating the user ID, the user name, and the department to which the user belongs included in the information received by the data exchange unit 51 (see FIG. 8B) (step S129).

After the information is registered in the account management table in step S129, the data exchange unit 51 transmits to the PC 6 data on a shared workspace usage guide screen (shared workspace usage guide screen data) in addition to the user ID and the password, which are associated with the administrator (step S130). Accordingly, the data exchange unit 61 of the PC 6 receives the user ID and the password, which are associated with the administrator, and the shared workspace usage guide screen data transmitted from the management assistance server 5.

Then, the acquisition unit 66 of the PC 6 registers the user ID and the password in the administrator registration table (see FIG. 5C) as the user information of the authenticated user, the administrator. (step S131).

After that, the display control unit 24 causes the display 606 to display a shared workspace usage guide screen, which is described later in detail, and provide a notification of shared workspace usage guide to the administrator by using the shared workspace usage guide screen (step S132). In addition to the display of the screen on the display 606, the notification may be provided by voice sound via the speaker.

Example Screen:

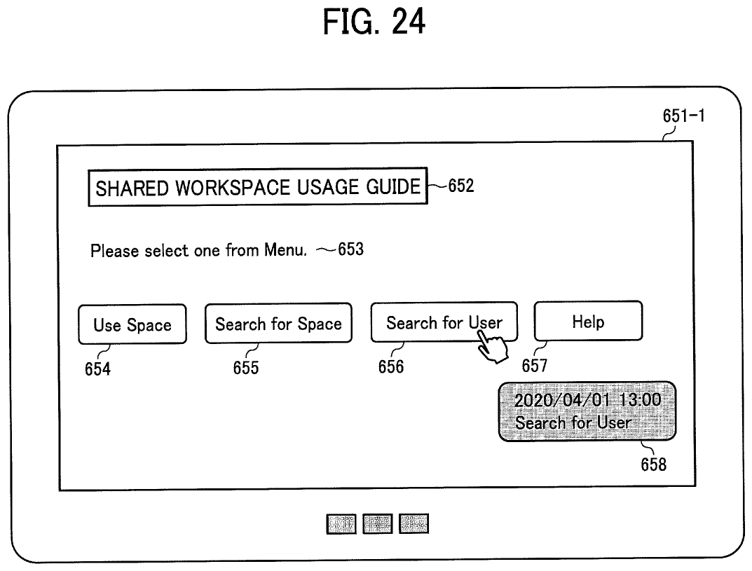

FIG. 24 is a diagram illustrating an example of a usage menu display screen, or a menu selection screen, displayed with a terminal for the administrator (administrator terminal) according to the first embodiment. As illustrated in FIG. 24, when the processing of step S132 described above is performed, the display control unit 64 causes the display 606 of the PC 6 to display a chat application screen 651-1 that includes, for example, a display part of “SHARED WORKSPACE USAGE GUIDE” 652, a message of “Please select one from menu.” 653, a “Use Space” button 654, a “Search for Space” button 655, a “Search for User” button 656, a “Help” button 657, and a text display field 658. At this time, in the text display field 658, “2020/04/01 13:00”, which indicates the current date and time, and “Search for User” are displayed.

User Search Process According to User Operation of Administrator:

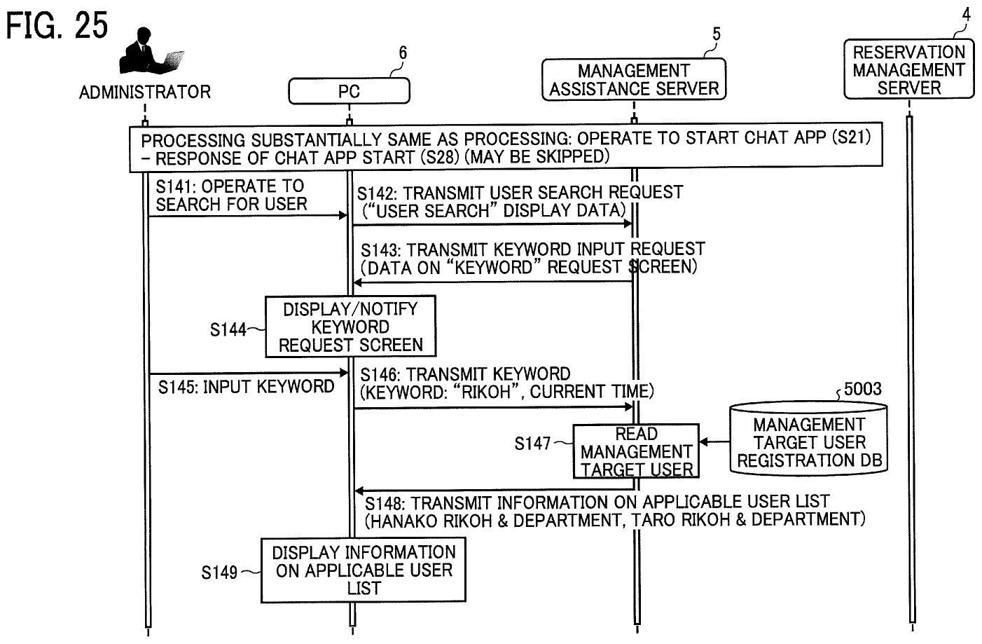

A description is given below of a process of searching for a user (user search process) according to user operations of the administrator. FIG. 25 is a sequence diagram illustrating an example of user search process performed according to user operations of the administrator according to the first embodiment. At this time, when the user search process is following to the above-described initial authentication process illustrated in FIG. 23, the processing from operating to start the chat application (application activation process) (corresponding to step S21 in FIG. 11) to starting the chat application (start response) (corresponding to step S28 in FIG. 11) can be skipped.

First, the administrator performs a user operation with respect to the “Search for User” button 656 for search for a user. For example, the administrator presses, clicks, or taps the “Search for User” button 656 included in the menu selection screen displayed as the chat application screen 651-1 illustrated in FIG. 24, which is described in detail later. Accordingly, the reception unit 62 of the PC 6 accepts a user search request (step S141).

Then, the data exchange unit 61 transmits to the management assistance server 5 a corresponding user search request in response to the user operation performed with respect to the “Search for User” button 656 (step S142). Accordingly, the data exchange unit 51 of the management assistance server 5 receives the user search request transmitted from the PC 6.

After the processing of step S142 is performed, the data exchange unit 51 transmits a keyword input request (an example of a first request) to the PC 6 (step S143). Accordingly, the data exchange unit 61 of the PC 6 receives the keyword input request transmitted from the management assistance server 5.

Then, the display control unit 64 causes the display 606 of the PC 6 to display a keyword request screen (step S144).

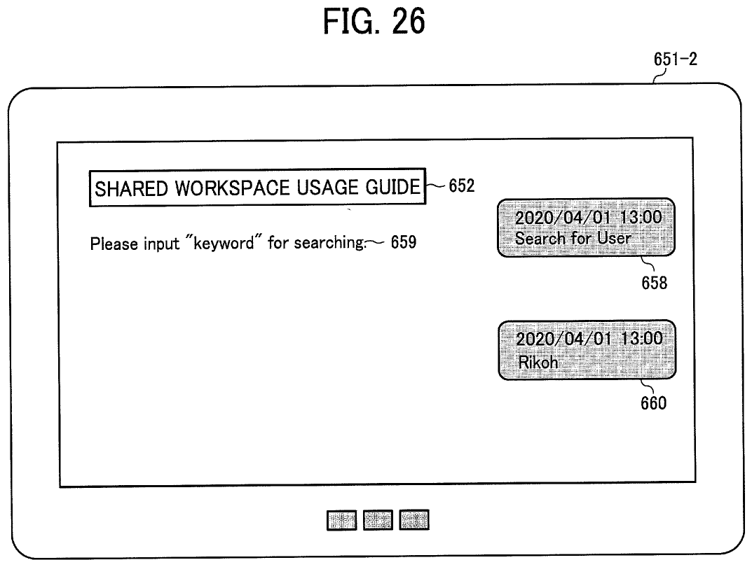

The administrator who confirms the keyword request screen displayed on the display 606 of the PC 6 performs a user operation that is inputting one or more keywords, namely performs a keyword input operation on the display 606. Accordingly, the reception unit 62 of the PC 6 receives the input operation (step S145). In the description of the present embodiment, for example, as illustrated in FIG. 26, “Rikoh” is input in a “text input” field 660, which is described in detail later. A detailed description of the screen is given later with an example screen.

Then, the data exchange unit 61 transmits to the management assistance server 5 information indicating “Rikoh” received as a keyword (an example of an instruction transmitted as a response to the first request), and information on a current time (current time information) indicated by the PC 6 (step S146). Accordingly, the data exchange unit 51 of the management assistance server 5 receives the information indicating “Rikoh” and the current time information indicating the current time indicated by the PC 6, which are transmitted from the PC 6. As for the current time, time information managed by the clock unit 53 of the management assistance server 5 may be used. In that case, the current tune information is not received in step S146.

Upon receiving the keyword in step S146, the management assistance server 5 performs search for one or more users who are applicable to the keyword. Specifically, the storing and reading unit 59 searches the management target user registration table (see FIG. 9) by using the received keyword of “Rikoh” as a search key to read one or more applicable management target users (step S147). In addition, in alternative to the processing of step S147, another method of extracting a management target user may be used. For example, the administrator accesses the reservation management server 4, which manages the user information, by using a predetermined keyword, refers to the user information managed by the reservation management server 4, and generates a list of applicable users corresponding to the management target users.

Then, information, which is on one or more users who are applicable to the keyword of “*** Rikoh” and who are corresponding to the management target users, is read by the storing and reading unit 59 and transmitted to the PC 6 (step S148). The information may be a list of applicable users (applicable user list) and may be referred to as applicable user information, hereinafter. Accordingly, the data exchange unit 61 of the PC 6 receives the applicable user information (applicable user list) transmitted from the management assistance server 5. In the description of the present embodiment, for example, the applicable user information (applicable user list) includes “Taro Rikoh” and “Hanako Rikoh” as applicable users. A department to which a corresponding user is belong is also displayed for each applicable user.

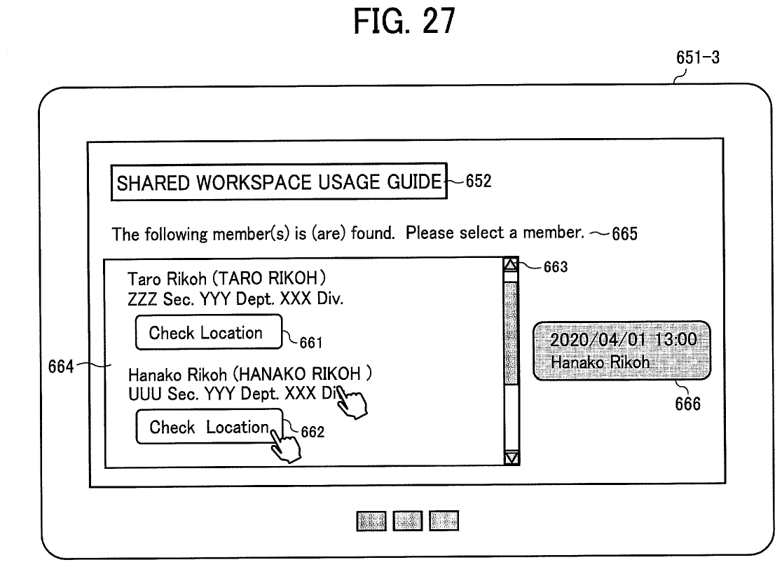

The display control unit 64 causes the display 606 of the PC 6, which has received the applicable user information from the management assistance server 5, to display a chat application screen 651-3 displaying applicable users (applicable user list) as illustrated in FIG. 27 (step S149). As a result, the administrator is notified of the applicable users, the information on “Taro Rikoh” and his department, and “Hanako Rikoh” and her department at the current time.

Example Screen:

FIG. 26 is a diagram illustrating an example of a user search screen displayed with the administrator terminal according to the first embodiment. As illustrated in FIG. 26, when the processing of step S144 described above is performed, the display control unit 64 causes the display 606 of the PC 6 to display a chat application screen 651-2 that includes, for example, the display part of “SHARED WORKSPACE USAGE GUIDE” 652, a message of “Please input “keyword” for searching.” 653, the text display field 658, and the text display field 660, which is also serves as the “text input” field. At this time, in the text display field 658, “2020/04/01 13:00”, which indicates the current date and time, and “Search for User” are displayed. Further, in the text display field 660, which is also serves as the “text input” field, “2020/04/01 13:00”, which indicates the current date and time, and “Rikoh” are displayed.

FIG. 27 is a diagram illustrating an example of a screen displayed with the administrator terminal displaying information on the applicable users as a search result, according to the first embodiment. As illustrated in FIG. 27, when the processing of step S149 described above is performed, the display control unit 64 causes the display 606 of the PC 6 to display the chat application screen 651-3 that includes, for example, the display part of “SHARED WORKSPACE USAGE GUIDE” 652 and a message of “the following member(s) is(are) found. Please select a member.” 665, an applicable user information display field 664, and a text display field 666. At this time, “2020/04/01 13:01”, which indicates the current date and time, and “Hanako Rikoh” are displayed in the text display field 666.

Further, in the applicable user information display field 664, “Taro Rikoh” and his department, a “Check Location” button 661, “Hanako Rikoh”, and her department, and a “Check Location” button 662 are displayed. Further, a scroll bar 663 is provided on the right side of the applicable user information display field 664. “Hanako Rikoh” displayed in the text display field 666 is displayed when, for example, the “Check Location” button 662, which is corresponding to “Hanako Rikoh” and which is located under “Rikoh Hanako” and the information on the department, is pressed or tapped by the administrator. In addition, as for displaying “Hanako Rikoh” in the text display field 666, in alternative to operating the “Check Location” button 662, for example, a user interface (UI) with which a part of the text of either the user name or the department is operatable by pressing, clicking, or tapping by the administrator may be used.

Process of Specifying User Among from Applicable Users by Management Assistance Server 5:

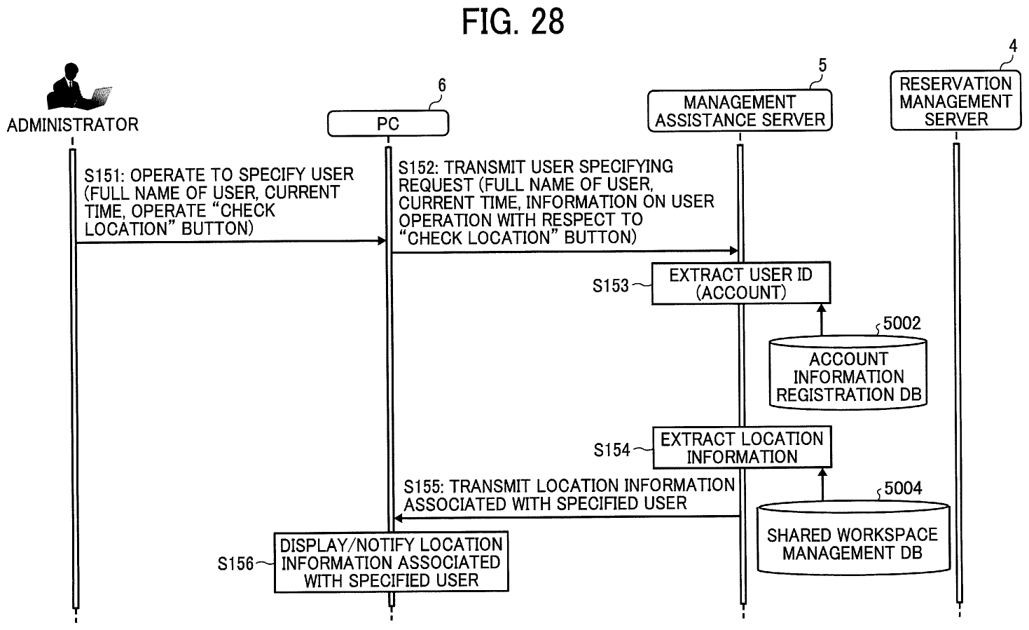

A description is given below of a process of specifying one applicable user among from the applicable users, performed by the management assistance server 5. FIG. 28 is a sequence diagram illustrating an example of user search process performed according to one or more user operations of the administrator according to the first embodiment. As illustrated in FIG. 28, first, the administrator performs a user operation with respect to a corresponding “Check Location” button associated with a target user for specifying his or her location, among the applicable users displayed in the applicable user information display field 664 illustrated in FIG. 27 described above. The user operation for specifying a user is, for example, pressing, clicking, or tapping, the corresponding “Check Location” button. hi the description of the present embodiment, for example, the administrator presses, clicks, or taps the “Check Location” button 662 in order to specify a user to “Rikoh Hanako” who is one of the applicable users and to obtain information on the location of “Rikoh Hanako”. The information on the location may be referred to as location information, hereinafter. Accordingly, the reception unit 62 of the PC 6 receives the user operation of specifying a user (step S151).

Then, the data exchange unit 61 transmits to the management assistance server 5 a user specifying request corresponding to the “Check Location” button 662 (step S152). Accordingly, the data exchange unit 51 of the management assistance server 5 receives the user specifying request transmitted from the PC 6. The user specifying request includes a full name of the corresponding user and the department to which the corresponding user belongs. The user specifying request transmitted in step S152 is an example of an additional instruction that is a response to a second request.

Then, the storing and reading unit 59 of the management assistance server 5 searches the account information management table (see FIG. 8B) by using the information received by the data exchange unit 51, a set of “Hanako Rikoh”, which indicates the full name of the user, and the department to which the user belongs, as a search key to read the corresponding user ID (account) (step S153).

In addition, the storing and reading unit 59 searches the shared workspace management table (see FIG. 10) using the user ID (account) read in the processing of step S153 as a search key to read an associated shared workspace name (step S154). As a result, the determination unit 55 identifies the shared workspace name of the resource (shared workspace A) reserved by the specified user who is a search target.

Then, the data exchange unit 51 transmits to the PC 6 the resource name of the resource (shared workspace name) reserved by the specified user (step S155). Accordingly, the data exchange unit 61 of the PC 6 receives the resource name transmitted from the management assistance server 5.

With respect to the resource name received in step S155, the display control unit 64 causes the display 606 of the PC 6 to display the location of the resource reserved by the specified user (step S156).

Example Screen:

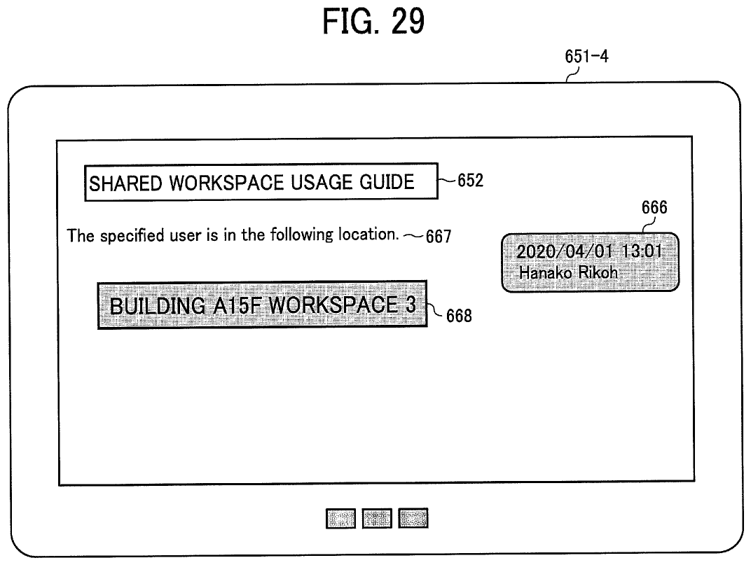

FIG. 29 is a diagram illustrating an example of a user search result screen displayed with the administrator terminal according to the first embodiment. As illustrated in FIG. 29, when the processing of step S156 described above is performed, the display control unit 64 causes the display 606 of the PC 6 to display the chat application screen 651-4 that includes, for example, the display part of “SHARED WORKSPACE USAGE GUIDE” 652, a message of “The specified user is in the following location.” 667, a message display field 668, and the text display field 666. At this time, in the message display field 668, “BUILDING A 15F WORKSPACE 3” indicating the name of the resource that is reserved by the specified user (Hanako Rikoh) is displayed. In the present embodiment, the “BUILDING A 15F WORKSPACE 3” is an example of the location information indicating a location of a specific resource. Further, in the text display field 666, “2020/04/01 13:01”, which indicates the current date and time, and “Hanako Rikoh” are displayed.

As described above, according to the first embodiment, the management assistance server 5 receives an ID for identifying a shared workspace A, which is excluded from being subjects to be directly reserved by the reservation management server 4 and which is to be used by User A, and the user ID of User A (step S82). The ID and the user ID are transmitted from the smartphone 2 owned or used by User A. In addition, the management assistance server 5 transmits, to the administrator terminal owned or used by the administrator who manages User A, information on user name of User A and location information indicating where the shared workspace corresponding to the ID of the shared workspace A is (step S155). This allows the administrator who manages User A to easily know the location of User A (location reserved by User A) who uses the shared workspace. That is, the administrator easily gets information on the location of the user who uses the shared workspace that is not managed by the reservation management server 4 by starting a chat application with respect to the management assistance server 5.

### Second Embodiment

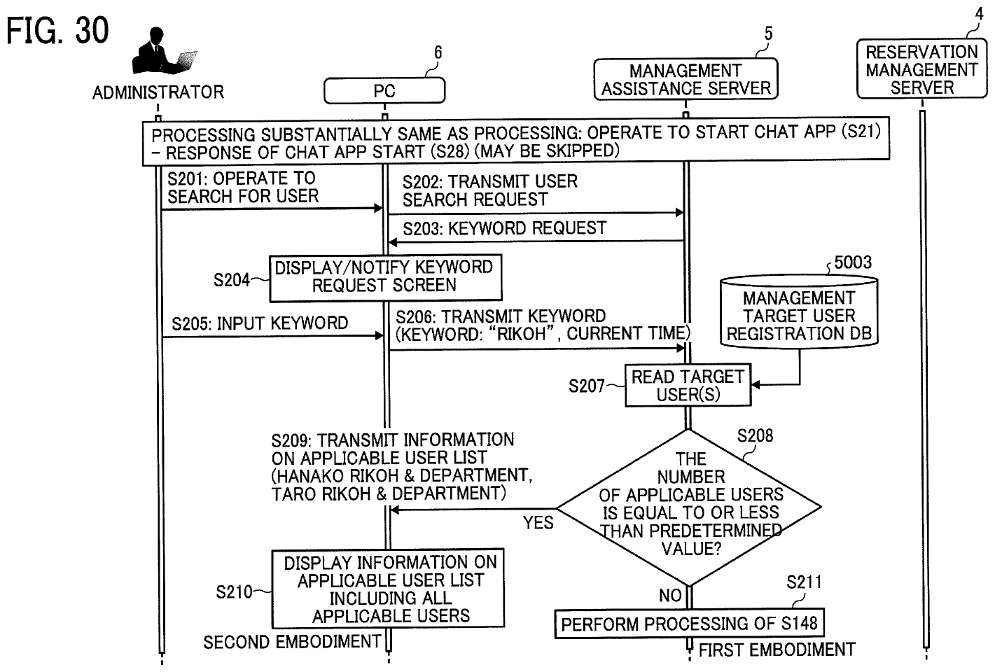

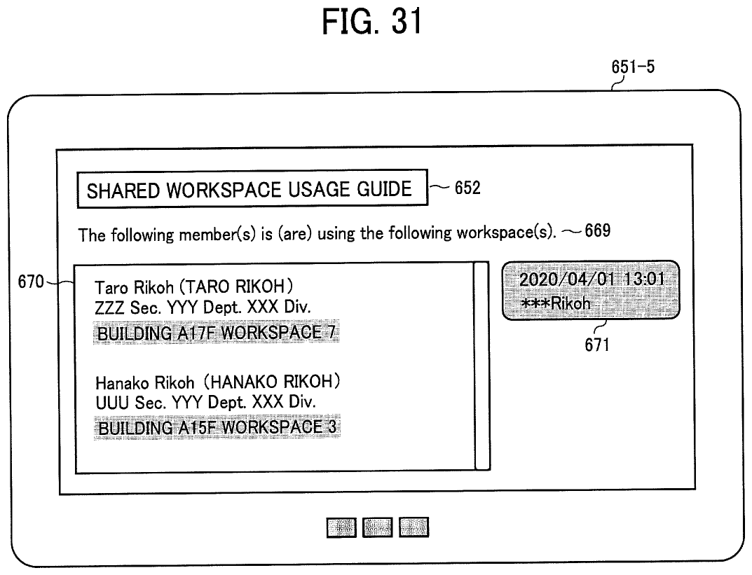

A description is given below of a second embodiment of the present disclosure, with reference to FIG. 30 to FIG. 31. In the second embodiment, in a process of extracting applicable users performed by the management assistance server 5, when the number of applicable users is equal to or less than a predetermined value, information on a resource corresponding to each applicable user is transmitted to the PC 6, in alternative to the user specifying request corresponding to the user operation of the “Check Location” button (an example of the second instruction) (step S152). The predetermined value may be set by a designer or a user in advance. Since a system configuration, hardware configuration, and software function to which the second embodiment is applied are substantially the same as those described in the first embodiment, a redundant description thereof is omitted.

FIG. 30 is a sequence diagram illustrating an example of user search process performed according to user operations of the administrator according to the second embodiment. As illustrated in FIG. 30, processing of searching for a user performed according to user operations of the administrator, processing of steps S201 to S207, is substantially the same as the processing of steps S141 to S147 described in the first embodiment. Accordingly, the redundant description is omitted.

After the processing of reading the management target user is performed in step S207, the determination unit 55 of the management assistance server 5 determines whether the number of extracted applicable users is equal to or less than the predetermined value or not (step S208). When the number of extracted applicable users is equal to or less than the predetermined value (for example, 5 or less) (step S208: YES), the data exchange unit 51 transmits to the PC 6 all information related to the extracted applicable users (including each user name and each department to which a corresponding user belongs) (step S209). Accordingly, the data exchange unit 61 of the PC 6 receives all the information (including each user name and each department to which a corresponding user belongs) associated with the applicable users transmitted from the management assistance server 5.

After receiving all the information associated with the applicable users, the display control unit 64 causes the display 606 of the PC 6 to display in the applicable user information display field 670 the applicable user information including the user names, the departments, and the resource names (shared workspace names) that are reserved by the corresponding applicable users, as illustrated in FIG. 31 (step S210). In the description of the present embodiment, as illustrated in FIG. 31, for example, two users are found as the applicable users. This allows the administrator to know the location of the resource (shared workspace) reserved by each user without performing the user operation for specifying the user, namely the administrator is not required to operate the “Check Location” button on the display 606 of the PC 6 to specify the user.

On the other hand, when the number of extracted applicable users is more than the predetermined value (step S208: NO), the determination unit 55 performs the same processing as in step S148, and the process proceeds with the following steps (step S211).

Example Screen:

FIG. 31 is a diagram illustrating an example of a screen displayed with the administrator terminal displaying information on applicable users as a search result according to the second embodiment. As illustrated in FIG. 31, when the processing of step S210 described above is performed, the display control unit 64 causes the display 606 of the PC 6 to display a chat application screen 651-5 that includes, for example, the display part of “SHARED WORKSPACE USAGE GUIDE” 652, a message of “The following member(s) is (are) using the following shared workspace(s).” 669, the applicable user information display field 670, and a text display field 671. At this time, in the applicable user information display field 670, a name of a specified user (Taro Rikoh), a department to which the specified user belongs, and a resource name of a resource that is reserved by “Taro Rikoh”, “BUILDING A 17F WORKSPACE 7”, are displayed. Further, in the applicable user information display field 670, another name of another specified user (Hanako Rikoh), another department to which the other specified user belongs, and another resource name of another resource that is reserved by “Hanaoko Rikoh”, “BUILDING A 15F WORKSPACE 3”, are displayed. Further, in the text display field 671, “2020/04/01 13:01”, which indicates the current date and time, and “***Rikoh” are displayed.

As described above, according to the second embodiment, the determination unit 55 of the management assistance server 5 determines whether the number of extracted applicable users is equal to or less than the predetermined value (step S208). When the number of extracted applicable users is equal to or less than the predetermined value (step S208: YES), the data exchange unit 51 transmits to the PC 6 all the information associated with the extracted applicable users (including each user name and each department to which the corresponding user belongs) (step S209). After receiving all the information associated with the applicable users, the display control unit 64 causes the display 606 of the PC 6 to display in the applicable user information display field 670 the applicable user information including the user names, the departments, and the resource names (shared workspace names) that are reserved by the applicable users (step S210). This allows the administrator to know the location of the resource (shared workspace) reserved by each user without performing the user operation for specifying the user, namely the administrator is not required to operate the “Check Location” button on the display 606 of the PC 6 to specify the user.

### Other Embodiments

Log-Out Process According to Operation of User A:

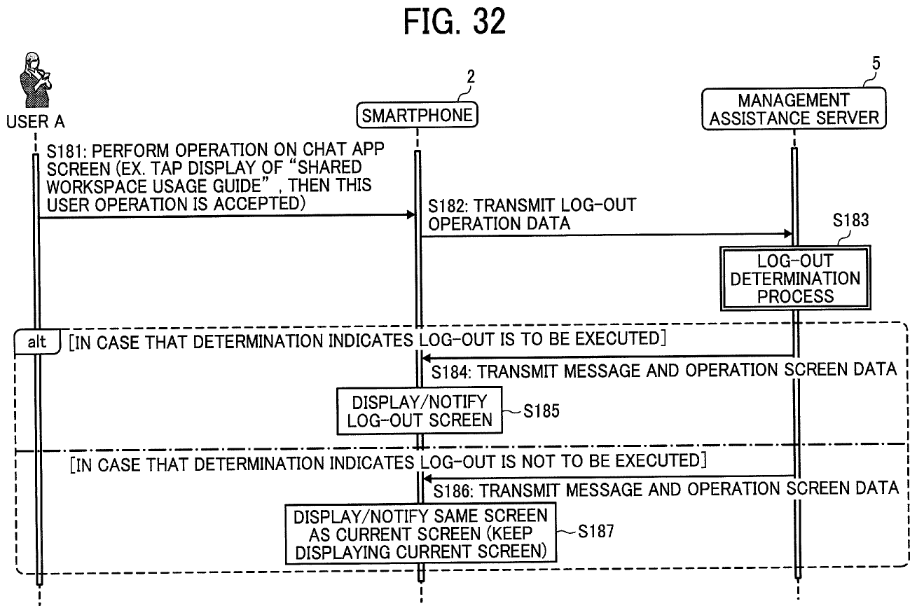

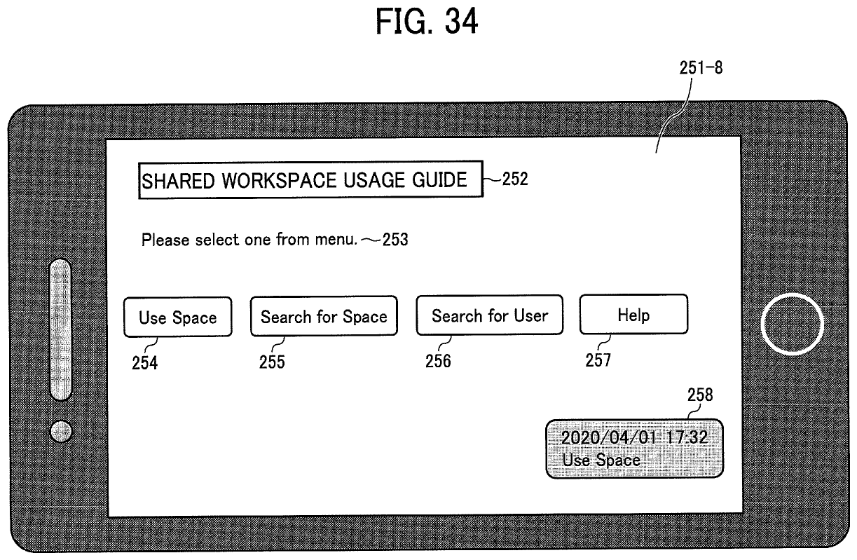

FIG. 32 is a sequence diagram illustrating an example of a chat application log-out process performed in response to a user operation of User A, according to one of the embodiments. First, User A performs a user operation with respect to a screen of the smartphone 2 for logging out from the chat application (step S181). Accordingly, the reception unit 22 of the smartphone 2 receives the user operation with respect to the screen performed by User A. The operation for logging out may be pressing, clicking, or tapping a part of the display part of “SHARED WORKSPACE USAGE GUIDE” 252 on a chat application screen 251-8 as illustrated in FIG. 34, for example.

Then, the data exchange unit 21 transmits to the management assistance server 5 data on the operation for logging out (step S182). The data on the operation for logging out may be referred to as log-out operation data. Accordingly, the data exchange unit 51 of the management assistance server 5 receives the log-out operation data transmitted from the smartphone 2.

Then, the determination unit 55 of the management assistance server 5 determines whether the log-out is to be executed or not (log-out determination process) as described below (step S183).

Details of Log-Out Process According to Operation of User A:

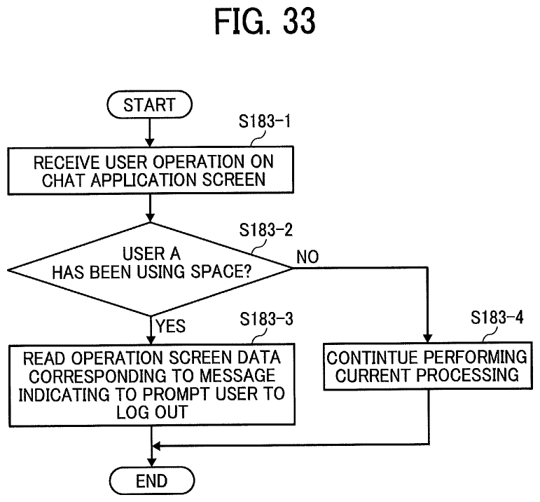

FIG. 33 is a flowchart illustrating an example of log-out determination process in relation to the chat application, performed in response to a user operation of User A, according to one of the embodiments. First, the determination unit 55 receives a user operation performed with respect to the chat application screen via the reception unit 22 (step S183-1).

Next, the determination unit 55 determines whether User A has reserved an arbitrary space and is currently using the arbitrary space (step S183-2). When a result of the determination indicates that User A has reserved the arbitrary space and is currently using the arbitrary space (step S183-2: YES), the determination unit 55 reads, from a storage unit of the management assistance server 5, operation screen data corresponding to one of a message inquiring about the continuation of the reservation and a message prompting the log-out process, for example (step S183-3). Then the process of the flowchart ends.

On the other hand, when the result of the determination indicates that an arbitrary space is not currently in a status of being reserved by User A (step S183-2: NO), the determination unit 55 determines that there is no processing corresponding to log-out to be executed and continues performing a current processing (step S183-4).

Case that Log-Out Process is to be Executed:

Returning to FIG. 32, a case that the log-out process is to be executed is be described. After the processing of step S183-3 in FIG. 33, the data exchange unit 51 transmits one of the message inquiring about the continuation of the reservation and the other message prompting the log-out process, in addition to operation screen data corresponding to each message to the smartphone 2 (step S184). Accordingly, the data exchange unit 21 of the smartphone 2 receives the message inquiring about the continuation of the reservation with the corresponding operation screen data or the message prompting a log-out process with the corresponding operation screen data transmitted from the management assistance server 5.

Then, the display control unit 24 causes the display 218 of the smartphone 2 to display an operation screen (for example, a log-out screen) corresponding to the received message (step S185).

Case that Log-Out Process is not to be Executed:

On the other hand, when the result of the determination indicates that the log-out process is not to be executed (S183-2 in FIG. 33: NO), a predetermined message indicating that the log-out process is not necessarily performed is transmitted with corresponding operation screen data to the smartphone 2. (Step S186). Accordingly, the data exchange unit 21 of the smartphone 2 receives the operation screen data corresponding to the message that indicates that the log-out process is not required, transmitted from the management assistance server 5.

Then, the display control unit 24 causes the display 218 of the smartphone 2 to display the operation screen corresponding to the received message (for example, a processing screen currently being executed) and continues the processing currently executed (step S187).

Example Screen:

FIG. 34 is a diagram illustrating an example of a usage menu display screen displayed with the communication terminal owned or used by User A. As illustrated in FIG. 34, when the processing of step S181 described above is performed, the display control unit 24 causes the display 218 of the smartphone 2 to display a chat application screen 251-8 that includes, for example, the display part of “SHARED WORKSPACE USAGE GUIDE” 252, the message of “Please select one from menu.” 253, the “Use Space” button 254, the “Search for Space” button 255, the “search for User” button 256, the “Help” button 257, and the text display field 258. At this time, in the text display field 258, “2020/04/01 17:32”, which indicates the current date and time, and “Use Space” are displayed. That is, the displayed content is almost the same as that in FIG. 15 described above.

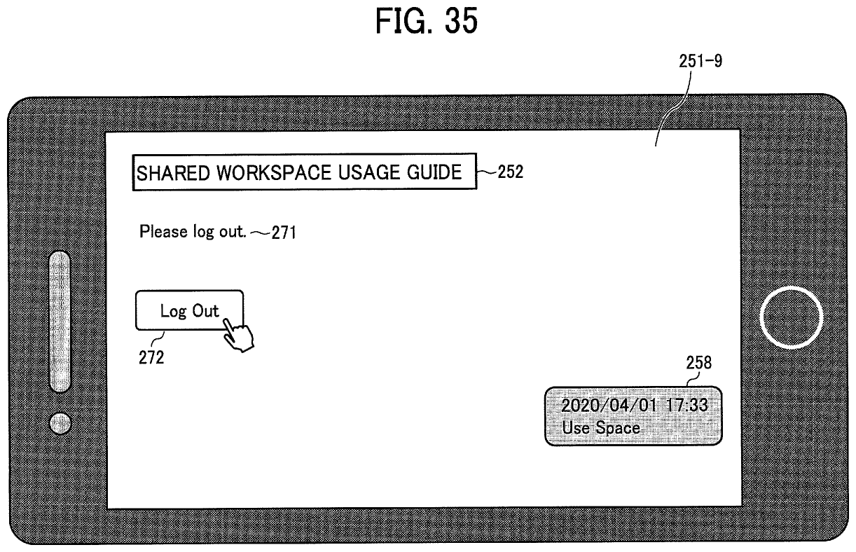

FIG. 35 is a diagram illustrating an example of a log-out screen displayed with a communication terminal owned or used by User A according to one of the embodiments. As illustrated in FIG. 35, when the processing of step S185 described above is performed, the display control unit 24 causes the display 218 of the smartphone 2 to display a chat application screen 251-9 that includes, for example, the display part of “SHARED WORKSPACE USAGE GUIDE” 252, a message of “Please log out.” 271, and a “Log Out” button 272. As a result, User A perfumes an operation such as pressing, clicking, or tapping with respect to the “Log Out” button 272 for executing the log-out process.

Variations:

The above-described embodiment is illustrative and does not limit the present disclosure. Thus, numerous additional modifications and variations are possible in light of the above teachings within the scope of the present disclosure. For example, elements and/or features of different illustrative embodiments may be combined with each other and/or substituted for each other within the scope of the present disclosure. Any one of the above-described operations may be performed in various other ways, for example, in an order different from the one described above.

That is, assisting management of the shared workspaces using QR CODE in the above-described embodiment is not limited to the shared workspaces, and for example, may be developed to a solution for company-owned vehicles, facilities, and the like.

The management system 1 according to the above-described embodiments may also be referred to as a “web service”. The web service refers to various services provided by the internet-related technologies. Examples of the web service include various rental services including a meeting room rental service. A system that uses the service is called a usage system.

The management system 1 according to the above-described embodiments may also be divided into the larger number of units according to the processing contents. In addition, a single processing unit can be further divided into a plurality of processing units.

Each of the functions of the embodiments described above may be implemented by one or more processing circuits or circuitry. The processing circuitry includes a programmed processor, as a processor includes circuitry. A processing circuit also includes devices such as an application specific integrated circuit (ASIC), a digital signal processor (DSP), a field programmable gate array (FPGA), a system on a chip (SOC), a graphics processing unit (GPU), and conventional circuit components arranged to perform the recited functions.

According to one of the above-described embodiments, a management method is provided. The management method includes receiving, from a communication terminal used by a user, resource identification information and user identification information identifying the user. The resource identification information identifies a specific resource that is used by the user and excluded from being managed by a reservation management device that manages reservations for other resources. The management method further includes transmitting, to an administrator terminal used by an administrator who manages the user, user information and location information. The user information indicates a user name of the user who uses the specific resource and is identified by the user identification information. The location information indicates a location of the specific resource identified by the resource identification information.

However, in a conventional technique such as a technique in which current usage statues of all desks are referred, and available desks are selected to be randomly assigned one by one to each user, when a user uses a shared workspace that is not managed by a reservation management server that manages resource schedules, there is a case in which an administrator who manages the user does not know where the user is.

As described above, according to one or more embodiments of the disclosure, even when the user uses a shared workspace that is not managed by the reservation management server that manages resource schedules, the administrator who manages the user is able to easily know where the user is.

1. A management assistance device, comprising
circuitry configured to:
receive, from a communication terminal used by a user, user identification information identifying the user and resource identification information identifying a specific resource that is used by the user, the specific resource being a resource other than resources whose reservations are managed by a reservation management device; and
transmit, to an administrator terminal used by an administrator who manages the user, user information and location information, the user information indicating a user name of the user who uses the specific resource and is identified by the user identification information, the location information indicating a location of the specific resource identified by the resource identification information.

2. The management assistance device of claim 1,
wherein the circuitry further
transmits, to the administrator terminal, a first request for an instruction for searching for one or more users who are managed by the administrator,
receives, from the administrator terminal, a response to the first request, the response being the instruction for searching for the one or more users, and
transmits, to the administrator terminal, information on one or more applicable users obtained according to the instruction and a second request for an additional instruction for searching for a location of a resource being used by one of the one or more applicable users.

3. The management assistance device of claim 2,
wherein, when a number of the one or more applicable users is equal to or less than a predetermined value, the circuitry transmits, to the administrator terminal, information on one or more locations of one or more resources respectively used by the one or more applicable users in alternative to the second request.

4. The management assistance device of claim 1,
wherein the circuitry stores, in a memory,
department information indicating a department to which the user identified by the user identification information belongs, and
resource information including a status of the specific resource identified by the resource identification information corresponding to the user identification information,
wherein the circuitry further transmits, to the administrator terminal, the department information indicating the department to which the user identified by the user identification information belongs and the location information of the specific resource corresponding to the resource identification information, the department information and the location information being obtained as search results using the user identification information and the resource identification information, as search keys, respectively.

5. The management assistance device of claim 4,
wherein the circuitry transmits, to the communication terminal, resource name information indicating one or more names of one or more resources that are managed with the resource information and that are currently available.

6. The management assistance device of claim 5,
wherein the circuitry receives, from the communication terminal, code information embedded in a code provided in one of the one or more resources corresponding to the resource name information.

7. The management assistance device of claim 6,
wherein the code is QR CODE of which an image is captured by the communication terminal, and
wherein the circuitry receives the resource identification information and the location information, the resource identification information and the location information being embedded in QR CODE of which the image is captured.

8. The management assistance device of claim 2,
wherein the circuitry stores, in a memory, management target user information including information on each of the one or more users who use the resource in association with one of management target departments that are managed by the administrator, and
wherein the circuitry transmits, to the administrator terminal, information on the one or more applicable users among from the one or more users managed with the management target user information.

9. A management system, comprising:
a management assistance device including circuitry;
a communication terminal used by a user; and
an administrator terminal used by an administrator who manages the user,
the circuitry being configured to
receive, from the communication terminal, user identification information identifying the user and resource identification information identifying a specific resource that is used by the user, the specific resource being a resource other than resources whose reservations are managed by a reservation management device, and
transmit, to the administrator terminal, user information and location information, the user information indicating a user name of the user who uses the specific resource and is identified by the user identification information, the location information indicating a location of the specific resource identified by the resource identification information.

10. A non-transitory recording medium storing a plurality of instructions which, when executed by one or more processors, causes the processors to perform a method, the method comprising:
receiving, from a communication terminal used by a user, user identification information identifying the user and resource identification information identifying a specific resource that is used by the user, the specific resource being a resource other than resources whose reservations are managed by a reservation management device; and
transmitting, to an administrator terminal used by an administrator who manages the user, user information and location information, the user information indicating a user name of the user who uses the specific resource and is identified by the user identification information, the location information indicating a location of the specific resource identified by the resource identification information.
